(19) United States
(12) Patent Application Publication
(10) Pub. No.: US 2024/0359502 A1
(43) Pub. Date: Oct. 31, 2024

(54) WHEEL LOCK DEVICE FOR AUTOMOBILES

(71) Applicant: Jacky Rae Lane, Dr Mechanicsville, VA (US)

(72) Inventor: Jacky Rae Lane, Dr Mechanicsville, VA (US)

(21) Appl. No.: 18/646,842

(22) Filed: Apr. 26, 2024

Related U.S. Application Data
(60) Provisional application No. 63/498,278, filed on Apr. 26, 2023.

(51) Int. Cl. B60B 3/16

(52) U.S. Cl. CPC B60B 3/165

(57) ABSTRACT

A wheel lock device including a stopper member configured as one of a disc member, a conical frustum member, and a clamp member, is provided. The stopper member encloses an axle cover and together therewith, attaches to an axle hub of an automobile. The stopper member secures and precludes a wheel rim from dislodging from the automobile, when fasteners that attach the wheel rim to the automobile are unfastened accidentally. An outer diameter of the stopper member is larger than a central opening defined in the wheel rim, thereby restricting and precluding the wheel rim from dislodging from the automobile. The stopper member includes openings annularly disposed about a central opening of the stopper member for receiving bolts extending from an outer end of the axle hub. The stopper member is secured to the bolts extending from the outer end of the axle hub using bolt nuts.

### CROSS-REFERENCE TO RELATED APPLICATIONS

This application claims priority to and the benefit of the provisional patent application titled “Wheel Lock System For Automobiles”, application No. 63/498,278, filed in the United States Patent and Trademark Office on Apr. 26, 2023. The specification of the above-referenced patent application is incorporated herein by reference in its entirety.

### BACKGROUND

In dual-rim wheel automobiles such as medium to heavy duty trucks typically driven on highways, a wheel rim or, more particularly, an outer wheel rim, is fixed to a hub of an axle of the automobile using fasteners, for example, studs and lug nuts. The wheel rim houses a tire of the automobile. The wheel rim refers to an outer cylindrical edge of a wheel that holds the tire. Sometimes, when the automobile is in motion, the lug nuts unfasten accidentally and disengage from the studs, causing the wheel rim to dislodge from the automobile, which may cause serious accidents. In case of an accidental fall-off of the lug nuts, the wheel rim of a single-rim automobile or both an outer rim and an inner rim of a dual-rim automobile moves outwards and may cause the wheel(s) to accidentally dislodge from the automobile, resulting in an accident.

Hence, there is a long-felt need for a wheel lock device for an automobile, which secures a wheel rim of the automobile and precludes the wheel rim, and in turn, the wheel, from accidentally dislodging from the automobile.

### SUMMARY OF THE INVENTION

This summary is provided to introduce a selection of concepts in a simplified form that are further disclosed in the detailed description of the invention. This summary is not intended to determine the scope of the claimed subject matter.

The device disclosed herein addresses the above-recited need for a wheel lock device for an automobile, for example, a medium to heavy duty truck, which secures a wheel rim of the automobile and precludes the wheel rim, and in turn, a wheel of the automobile, from accidentally dislodging from the automobile. The wheel lock device bolts on to a hub of an axle of the automobile for preventing accidental dislodgement of the wheel rim, and in turn, the wheel, of the automobile.

The wheel lock device disclosed herein comprises a stopper member configured to enclose an axle cover and together with the axle cover, attach to an axle hub of an automobile. The stopper member is configured to secure and preclude a wheel rim from dislodging from the automobile, when fasteners, for example, lug nuts, that attach the wheel rim to the automobile are unfastened accidentally. An outer diameter of the stopper member is generally larger than a central opening defined in the wheel rim, thereby restricting and precluding the wheel rim from dislodging from the automobile. In an embodiment, the stopper member comprises multiple openings annularly disposed about a central opening of the stopper member. The openings are configured to receive bolts extending from an outer end of the axle hub. The stopper member is secured to the bolts extending from the outer end of the axle hub using bolt nuts.

In an embodiment, the stopper member is configured as a disc member configured to enclose an axle cover and together with the axle cover, attach to an axle hub of an automobile. The disc member together with the enclosed axle cover attaches to an outer end of the axle hub of the automobile. In an embodiment, the disc member comprises a generally circular plate with a central opening and a generally hollow cylindrical wall. The generally hollow cylindrical wall is configured to extend substantially perpendicularly from an edge of the generally circular plate. The generally circular plate and the generally hollow cylindrical wall of the disc member define an inner space configured to receive and enclose the axle cover. The disc member is configured as a stopper to secure and preclude a wheel rim from dislodging from the automobile, when fasteners, for example, lug nuts, that attach the wheel rim to the automobile are unfastened accidentally. The wheel rim is secured to the axle hub by fastening the lug nuts onto studs extending from an inner end of the axle hub. The axle hub is attached to a brake drum and an axle housing of the automobile. The wheel rim comprises an opening configured to fit over the axle hub. In an embodiment, the wheel rim is a single rim utilized in a single-rim automobile. In another embodiment, the wheel rim is a dual-rim utilized in a dual-rim automobile.

In an embodiment, the disc member comprises multiple openings annularly disposed about a central opening of the disc member. The openings are configured to receive bolts extending from the outer end of the axle hub. In an embodiment, the disc member is secured to the bolts extending from the outer end of the axle hub using bolt nuts. An outer diameter of the disc member is generally larger than a central opening defined in the wheel rim, thereby restricting and precluding the wheel rim from dislodging from the automobile.

In another embodiment, the stopper member is configured as a conical frustum member comprising a generally circular plate with a central opening and a generally hollow frustum wall. The generally hollow frustum wall is configured to extend angularly from an edge of the generally circular plate and terminate at a tapered end of the generally hollow frustum wall. In an embodiment, the tapered end of the generally hollow frustum wall of the conical frustum member comprises an outward edge and an inward edge configured to firmly secure the conical frustum member to the wheel rim. In an embodiment, the wheel lock device further comprises a compression material provided on the tapered end of the generally hollow frustum wall of the conical frustum member. The compression material at the tapered end of the generally hollow frustum wall of the conical frustum member is configured to compress against the wheel rim and firmly secure the conical frustum member to the wheel rim. In another embodiment, the tapered end of the generally hollow frustum wall of the conical frustum member is disposed a predetermined distance away from the wheel rim.

In another embodiment, the stopper member is configured as a clamp member comprising a first clamping element and a second clamping element configured to surround and enclose the axle cover. In an embodiment, the first clamping element and the second clamping element of the clamp member are generally hemispherical in shape. The clamp member further comprises arms extending outwardly from opposing ends of each of the first clamping element and the second clamping element. The arms of the first clamping element are pressure-fit connected to corresponding arms of the second clamping element using fasteners to secure the clamp member around the axle cover and preclude the wheel rim from dislodging from the automobile.

The wheel lock device disclosed herein is installed by first removing the bolt nuts that fix the axle cover to the axle hub of the automobile. After removing the bolt nuts, the wheel lock device is installed over the axle cover such that the wheel lock device encloses the axle cover. The wheel lock device together with the enclosed axle cover is then secured to the axle hub using the bolt nuts. If required, the bolts that are used to attach the wheel lock device and the enclosed axle cover are replaced with longer bolts to accommodate the added width of the wheel lock device.

The wheel lock device prevents the wheel rim and in turn, the wheel, of the automobile from coming off of the automobile when the lug nuts become loose and fall off of the studs. When the wheel lock device is installed in a single-rim automobile or a dual-rim automobile, if the wheel rim of the single-rim automobile or both the outer rim and the inner rim of the dual-rim automobiles moves outwards, the rim(s) and in turn, the wheel(s) are prevented from dislodging from the automobile by the wheel lock device which acts as a stopper.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific components, structures, and methods disclosed herein. In an embodiment, various structural elements are employed depending on design choices of a system designer. The description of a component or a structure referenced by a numeral in a drawing is applicable to the description of that component or structure shown by that same numeral in any subsequent drawing herein. The terms “front”, “rear”, “side”, “left”, “right”, “inner”, “outer”, etc., are based on an orientation or a positional relationship shown in the appended drawings, and are recited merely for describing the embodiments herein, rather than indicating or implying that the device, component, or structure referenced must have a particular orientation or position or must be constructed and operated in a particular orientation, and therefore should not be construed as limiting the embodiments herein.

FIG. 1A illustrates a front perspective view of an embodiment of a wheel lock device.

FIG. 1B illustrates a rear perspective view of the embodiment of the wheel lock device shown in FIG. 1A.

FIG. 1C illustrates a left-side elevation view of the embodiment of the wheel lock device shown in FIG. 1A, the right-side elevation view being a mirror image thereof.

FIG. 1D illustrates a rear elevation view of the embodiment of the wheel lock device shown in FIG. 1A.

FIG. 1E illustrates a cross-sectional view of the embodiment of the wheel lock device shown in FIG. 1A, taken along a sectional line E-E′ shown in FIG. 1D.

FIG. 2 illustrates a perspective view of a dual-rim automobile, showing wheel lock devices securing wheel rims to the dual-rim automobile.

FIG. 3A illustrates an exploded view of a dual-rim assembly utilized in the dual-rim automobile, showing the embodiment of the wheel lock device shown in FIG. 1A, configured to enclose an axle cover and attach to an axle hub of the dual-rim automobile.

FIG. 3B illustrates an exploded view of an embodiment of the dual-rim assembly utilized in the dual-rim automobile, showing the embodiment of the wheel lock device shown in FIG. 1A, configured to enclose an embodiment of the axle cover and attach to the axle hub of the dual-rim automobile.

FIG. 4 illustrates an assembled view of the dual-rim assembly shown in FIGS. 3A-3B, with the wheel lock device and the enclosed axle cover attached to the axle hub of the dual-rim automobile.

FIG. 5 illustrates a front elevation view of the dual-rim assembly shown in FIG. 4, with the wheel lock device and the enclosed axle cover attached to the axle hub of the dual-rim automobile.

FIG. 6A illustrates a cross-sectional, side elevation view of the dual-rim assembly, showing the embodiment of the wheel lock device shown in FIG. 1A configured to attach to the axle cover at an outer end of the axle hub using bolts and bolt nuts.

FIG. 6B illustrates a cross-sectional, side elevation view of the dual-rim assembly, showing the embodiment of the wheel lock device shown in FIG. 1A attached to the axle cover at the outer end of the axle hub using bolts and bolt nuts.

FIG. 7 illustrates a cross-sectional, side elevation view of the dual-rim assembly, showing operation of the wheel lock device as a stopper that secures and precludes a wheel rim from dislodging from an automobile, when fasteners that attach the wheel rim to the automobile are unfastened accidentally.

FIG. 8A illustrates a front perspective view of another embodiment of the wheel lock device.

FIG. 8B illustrates a rear perspective view of the embodiment of the wheel lock device shown in FIG. 8A.

FIG. 8C illustrates a left-side elevation view of the embodiment of the wheel lock device shown in FIG. 8A.

FIG. 8D illustrates a front elevation view of the embodiment of the wheel lock device shown in FIG. 8A.

FIG. 8E illustrates a rear elevation view of the embodiment of the wheel lock device shown in FIG. 8A.

FIG. 8F illustrates a cross-sectional view of the embodiment of the wheel lock device shown in FIG. 8A, taken along a sectional line F-F′ shown in FIG. 8E.

FIG. 9A illustrates an exploded view of a dual-rim assembly utilized in the dual-rim automobile, showing the embodiment of the wheel lock device shown in FIG. 8A, configured to enclose an axle cover and attach to an axle hub of the dual-rim automobile.

FIG. 9B illustrates an exploded view of an embodiment of the dual-rim assembly utilized in the dual-rim automobile, showing the embodiment of the wheel lock device shown in FIG. 8A, configured to enclose an embodiment of the axle cover and attach to the axle hub of the dual-rim automobile.

FIG. 10 illustrates a cross-sectional, side elevation view of the dual-rim assembly, showing the embodiment of the wheel lock device shown in FIG. 8A attached to the axle cover at the outer end of the axle hub using bolts and bolt nuts.

FIG. 11A illustrates a left-side perspective view of another embodiment of the wheel lock device.

FIG. 11B illustrates a right-side perspective view of the embodiment of the wheel lock device shown in FIG. 11A.

FIG. 11C illustrates an exploded, front elevation view of the embodiment of the wheel lock device shown in FIG. 11A.

FIG. 11D illustrates an assembled, front elevation view of the embodiment of the wheel lock device shown in FIG. 11A.

FIG. 11E illustrates a left-side elevation view of the embodiment of the wheel lock device shown in FIG. 11A.

FIG. 11F illustrates a cross-sectional view of the embodiment of the wheel lock device shown in FIG. 11A, taken along a sectional line X-X′ shown in FIG. 11E.

FIG. 12A illustrates an exploded view of a dual-rim assembly utilized in the dual-rim automobile, showing the embodiment of the wheel lock device shown in FIG. 11A, configured to enclose an axle cover and attach to an axle hub of the dual-rim automobile.

FIG. 12B illustrates an exploded view of an embodiment of the dual-rim assembly utilized in the dual-rim automobile, showing the embodiment of the wheel lock device shown in FIG. 11A, configured to enclose an embodiment of the axle cover and attach to the axle hub of the dual-rim automobile.

FIG. 13 illustrates a cross-sectional, side elevation view of the dual-rim assembly, showing the embodiment of the wheel lock device shown in FIG. 11A clamped around the axle cover.

FIG. 14 illustrates an embodiment of an electric truck axle hub.

FIG. 15 illustrates a front elevation view of another embodiment of the wheel lock device.

### DETAILED DESCRIPTION OF THE INVENTION

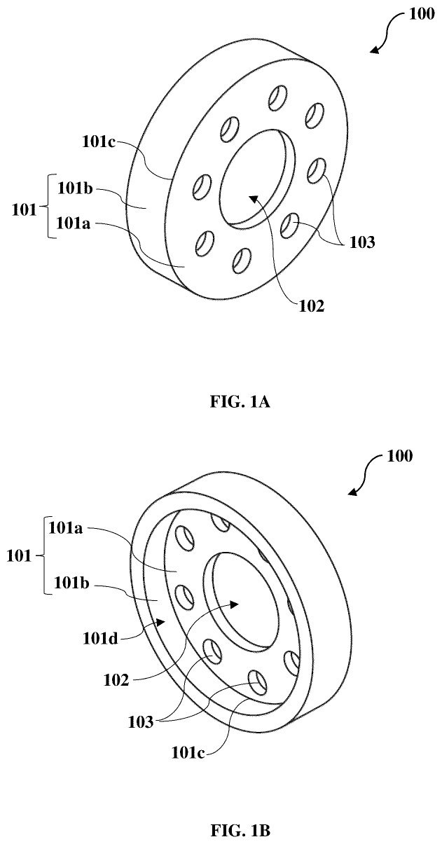

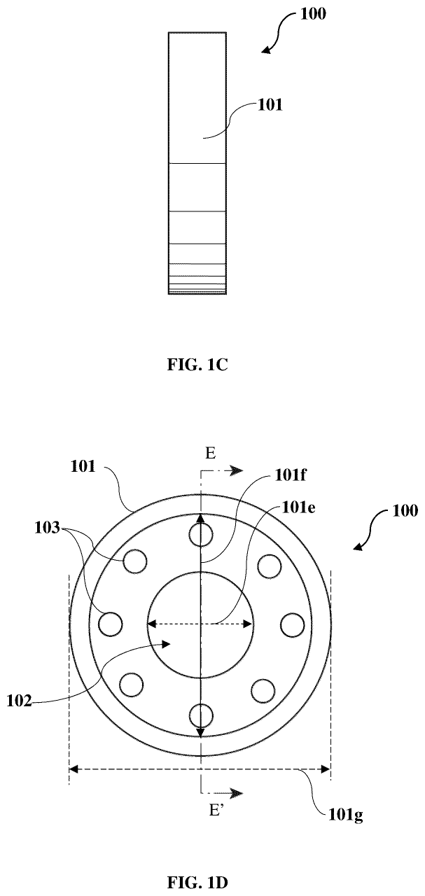

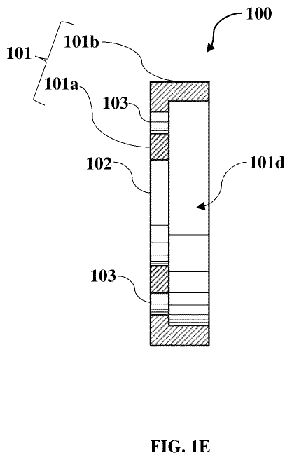

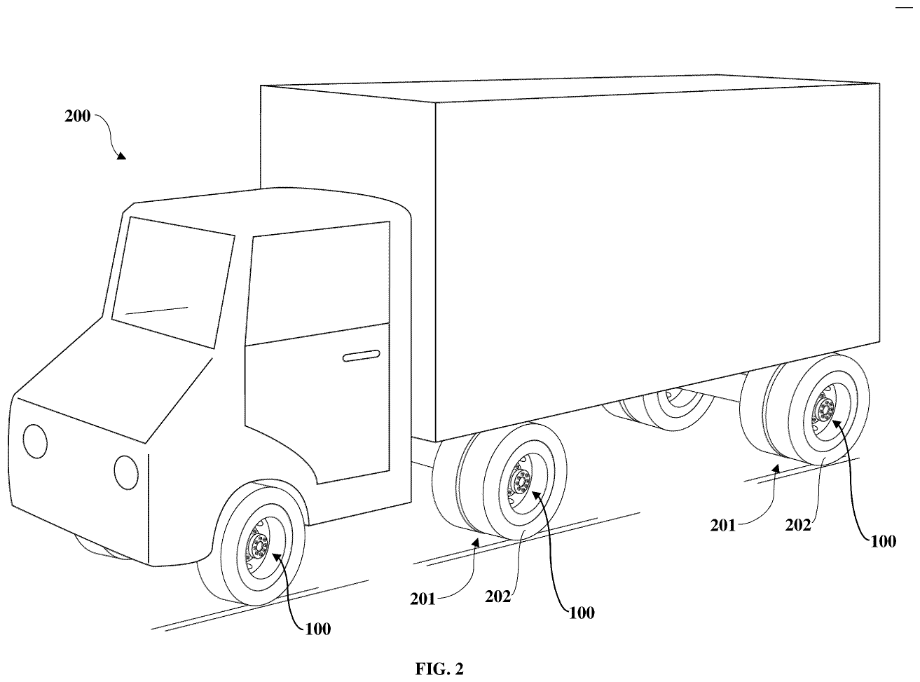

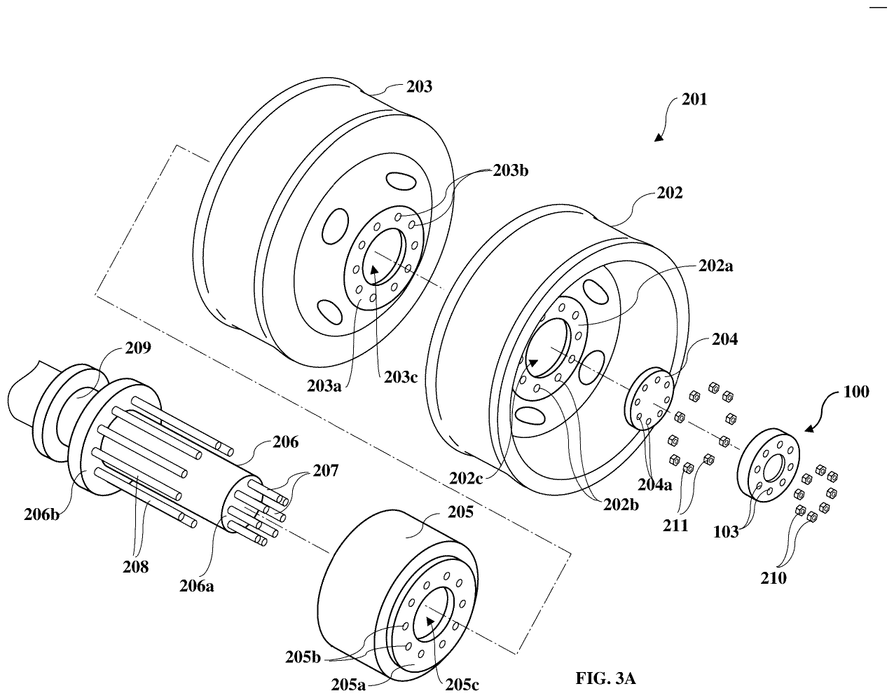

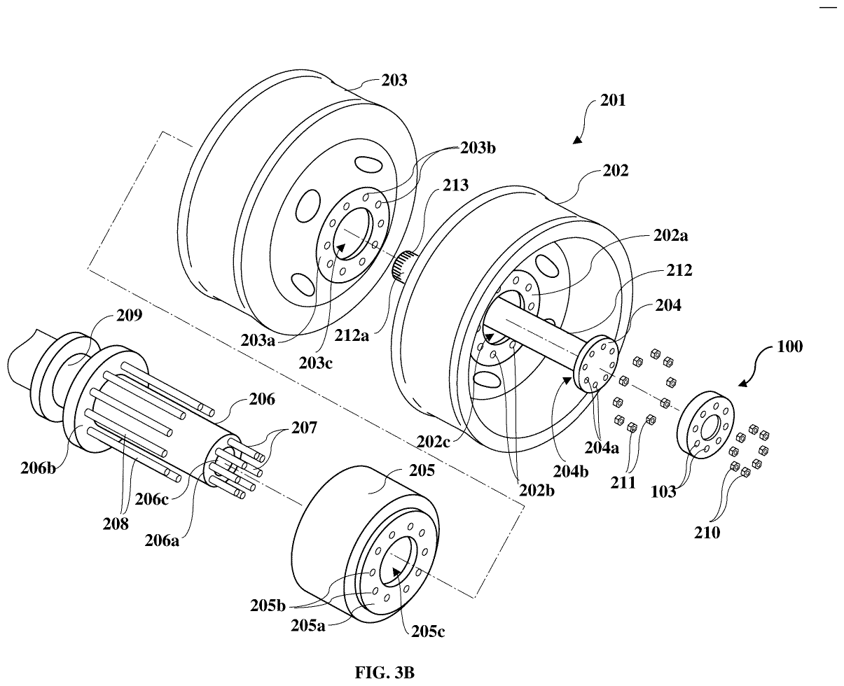

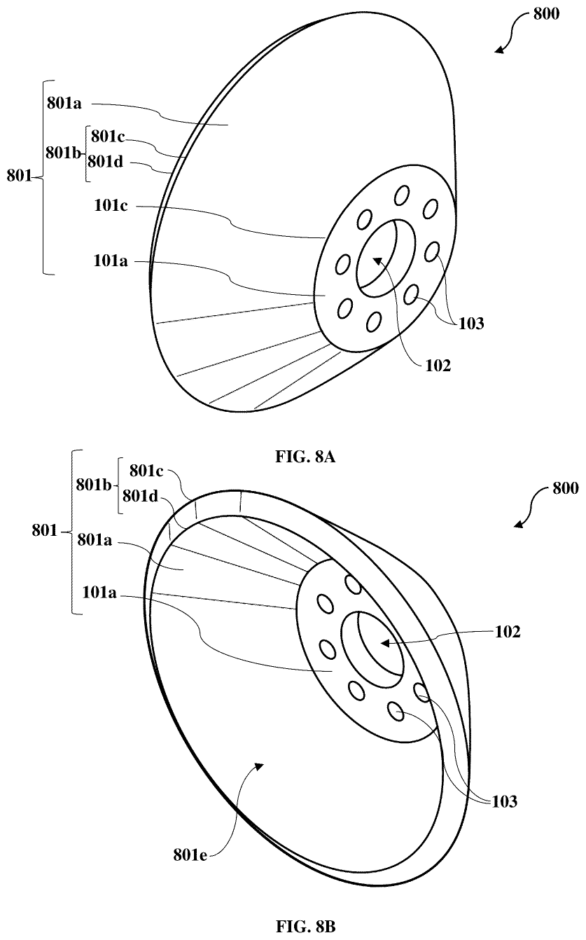

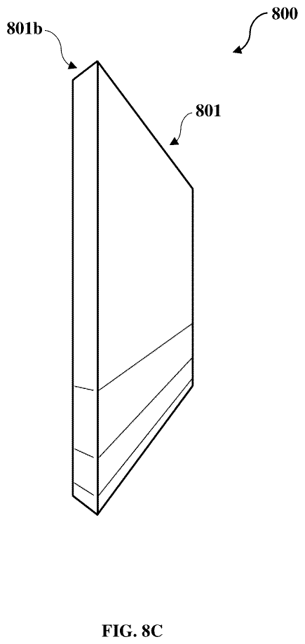

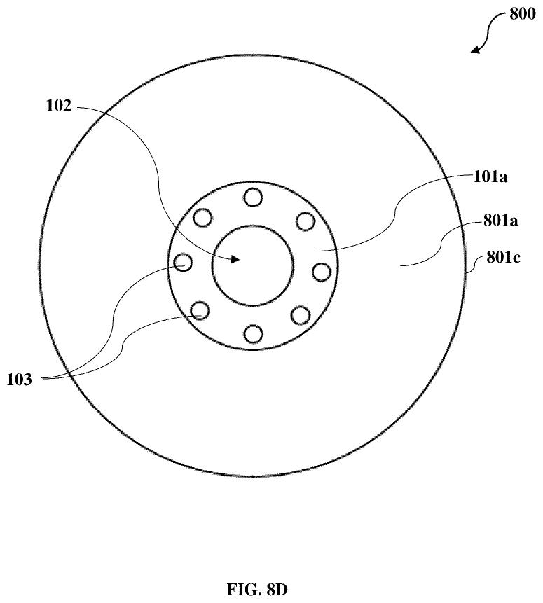

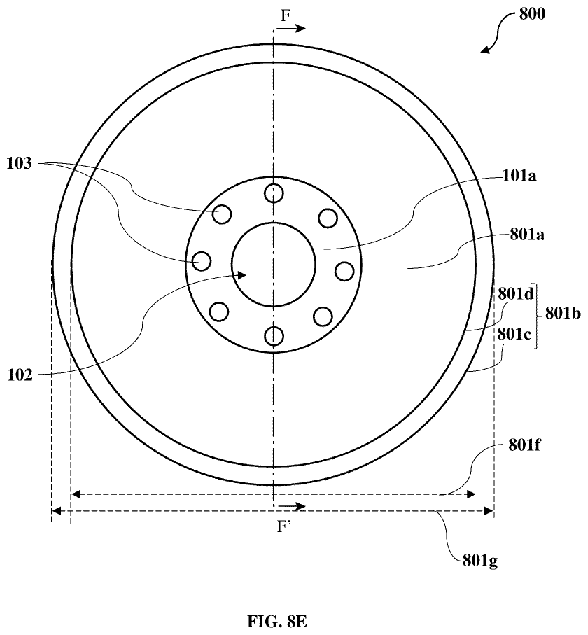

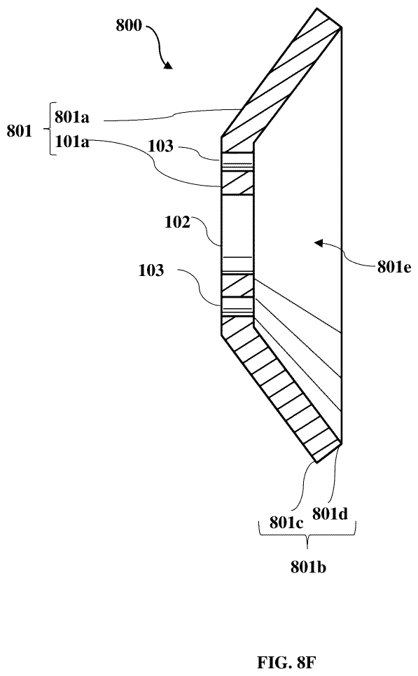

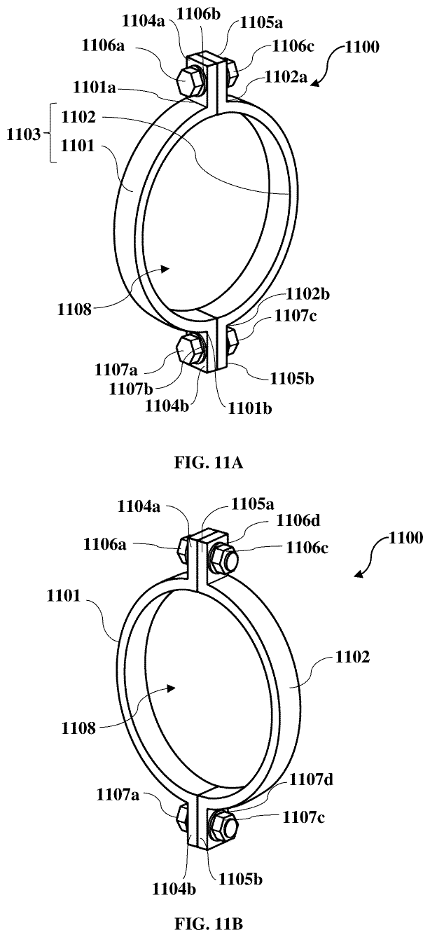

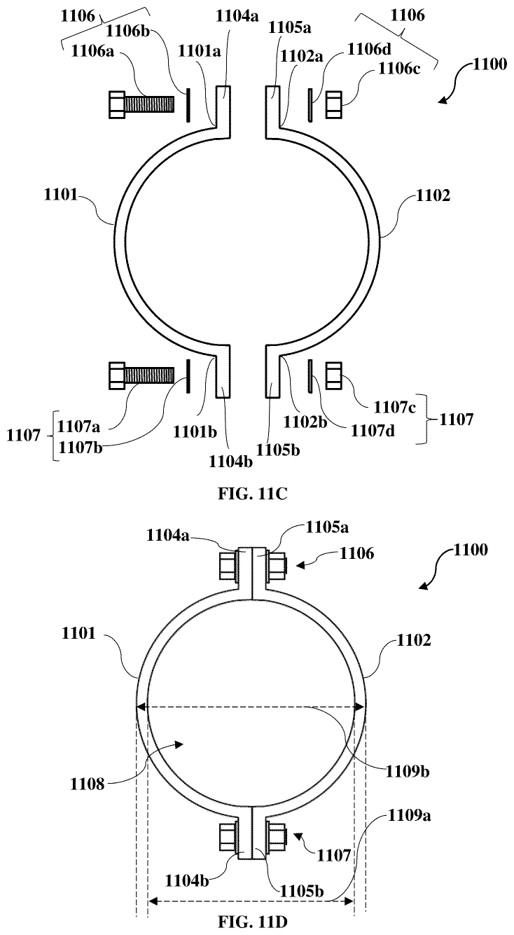

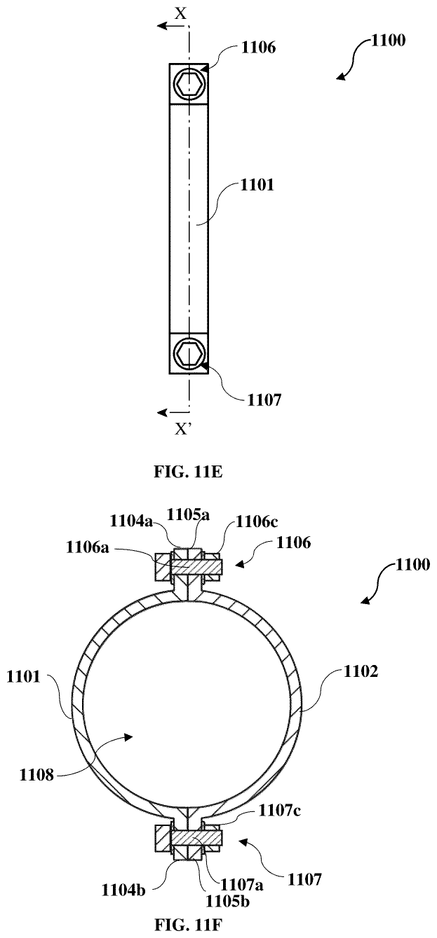

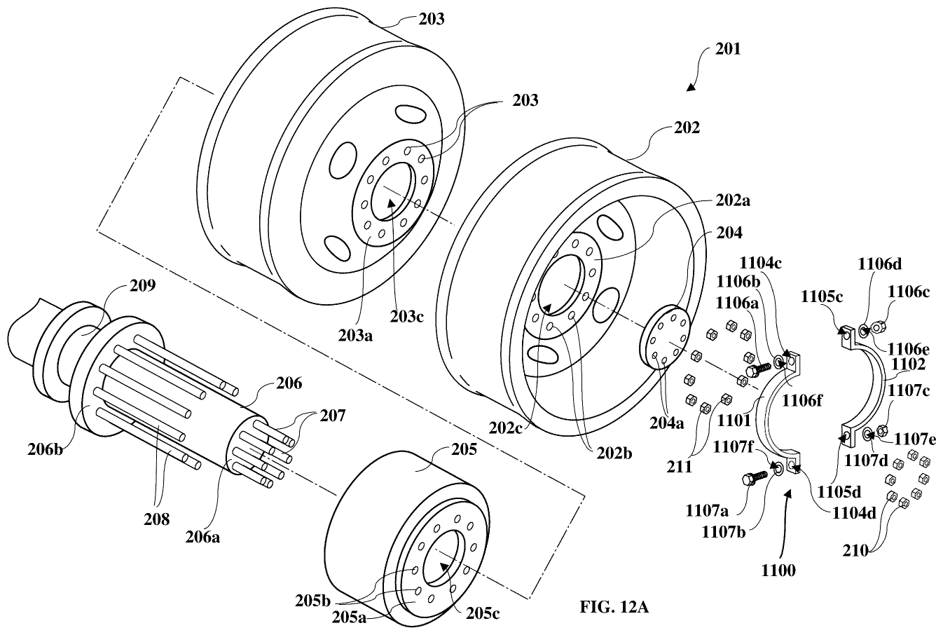

Disclosed herein is a wheel lock device 100/800/1100 comprising a stopper member 101/801/1103 configured to enclose an axle cover 204 and together with the axle cover 204, attach to an axle hub 206 of an automobile 200 as illustrated in FIG. 2, FIGS. 3A-3B, FIGS. 4-5, FIGS. 6A-6B, FIG. 7, FIGS. 9A-9B, FIG. 10, FIGS. 12A-12B, and FIG. 13. In various embodiments of the disclosure herein, the stopper member is configured as a disc member 101 as illustrated in FIGS. 1A-1E, a conical frustum member 801 as illustrated in FIGS. 8A-8F, and a clamp member 1103 as illustrated in FIGS. 11A-11F. The stopper member 101/801/1103 is configured to secure and preclude a wheel rim 202 from dislodging from the automobile 200 illustrated in FIG. 2 and FIGS. 3A-3B, when fasteners, for example, lug nuts 211 illustrated in FIGS. 3A-3B, FIGS. 4-5, FIGS. 6A-6B, FIGS. 9A-9B, FIG. 10, FIGS. 12A-12B, and FIG. 13, that attach the wheel rim 202 to the automobile 200 are unfastened accidentally as disclosed in the various embodiments below. The wheel lock devices 100, 800, and 1100 are made, for example, from steel, cast iron, aluminum, stainless steel, carbon steel, etc.

FIGS. 1A-1B illustrate a front perspective view and a rear perspective view of an embodiment of a wheel lock device 100, respectively. In the embodiment illustrated in FIGS. 1A-1B, the wheel lock device 100 comprises a disc member 101 configured as a stopper to secure a wheel rim 202 and preclude the wheel rim 202 from dislodging from an automobile 200 illustrated in FIG. 2, when fasteners, for example, lug nuts 211 illustrated in FIGS. 3A-3B, that attach the wheel rim 202 to the automobile 200 are unfastened accidentally. In an embodiment, the wheel rim is a single rim utilized in a single-rim automobile. In another embodiment, the wheel rim is a dual-rim utilized in a dual-rim automobile 200 as illustrated in FIG. 2. In an embodiment, the wheel lock device 100 is configured to be installed in any automobile that utilizes dual rims. Dual rims are utilized on both ends of a rear axle or a non-steering axle of the automobile 200. Examples of dual-rim automobiles comprise medium duty trucks, heavy duty trucks, semi-trucks, mining trucks, pickup trucks, utility trucks, dump trucks, tractors, tractor trailers, electric tractors with electric tandems, etc. In an embodiment as illustrated in FIGS. 1A-1B, the disc member 101 comprises a generally circular plate 101a with a central opening 102, and a generally hollow cylindrical wall 101b. In an embodiment, the generally circular plate 101a is a ring-shaped plate. The generally hollow cylindrical wall 101b is configured to extend substantially perpendicularly from an edge 101c of the generally circular plate 101a as illustrated in FIGS. 1A-1B. The generally circular plate 101a and the generally hollow cylindrical wall 101b of the disc member 101 define an inner space 101d as illustrated in FIG. 1B and FIG. 1E, configured to receive and enclose an axle cover 204 illustrated in FIGS. 3A-3B.

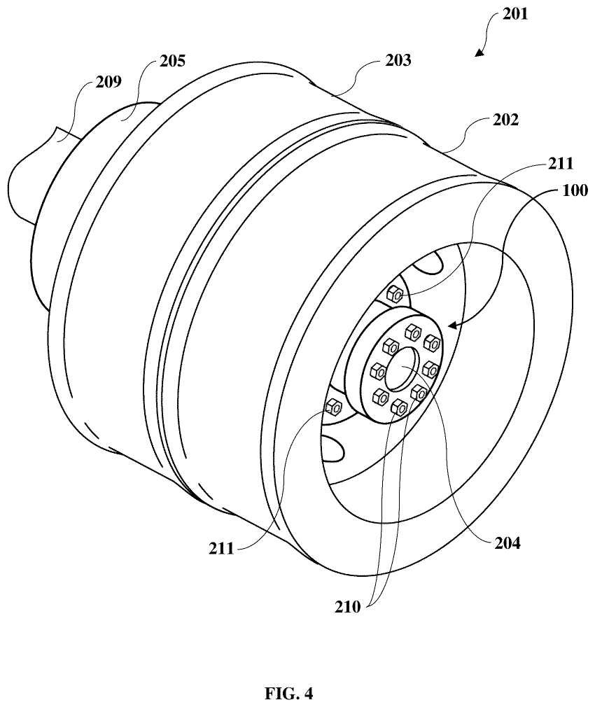

In an embodiment, the disc member 101 comprises multiple openings 103 annularly disposed about the central opening 102 of the disc member 101. The openings 103 are disposed on the generally circular plate 101a of the disc member 101 as illustrated in FIGS. 1A-1B and FIG. 1D. The openings 103 are configured, for example, as generally cylindrical openings with circular ends, to receive bolts 207 extending from an outer end 206a of an axle hub 206 as illustrated in FIGS. 3A-3B. In an example, the diameter of each of the openings 103 is about 1.25 inches. The distance between the centers of adjacent openings 103 on the generally circular plate 101a is, for example, about 2.6788 inches. The distance between the centers of diametrically opposite openings 103 is, for example, about 7 inches. The axle hub 206 is used to attach the wheel lock device 100 and the axle cover 204 shown in FIGS. 3A-3B to the automobile 200 as disclosed in the descriptions of FIGS. 3A-3B and FIG. 4.

FIG. 1C illustrates a left-side elevation view of the wheel lock device 100, the right-side elevation view being a mirror image thereof. FIG. 1D illustrates a rear elevation view of the wheel lock device 100. As illustrated in FIG. 1D, the generally circular plate 101a of the disc member 101 of the wheel lock device 100 comprises an inner diameter 101e defining the central opening 102 and an outer diameter 101f. The inner diameter 101e of the generally circular plate 101a is, for example, about 5.5 inches. The outer diameter 101f of the generally circular plate 101a is, for example, about 8.5 inches. The thickness of the generally circular plate 101a of the disc member 101 is, for example, about 0.5625 inches. The thickness of the generally hollow cylindrical wall 101b is, for example, about 0.75 inches. The height of the generally hollow cylindrical wall 101b is, for example, about 1 inch. The outer diameter 101g of the disc member 101 is, for example, about 10 inches. The outer diameter 101g of the wheel lock device 100 is generally larger than the outer diameter of a central opening in a wheel rim of a single-rim automobile or larger than the outer diameter of a central opening 202c in an outer rim 202 of a dual-rim automobile 200 shown in FIGS. 3A-3B. The single-rim or the outer rim 202, therefore, cannot get past the wheel lock device 100.

FIG. 1E illustrates a cross-sectional view of the wheel lock device 100, taken along a sectional line E-E′ shown in FIG. 1D. The cross-sectional view in FIG. 1E illustrates the inner space 101d defined by the generally circular plate 101a and the generally hollow cylindrical wall 101b of the disc member 101. The cross-sectional view in FIG. 1E also illustrates the openings 103 disposed on the generally circular plate 101a of the disc member 101. The openings 103 are, for example, generally cylindrical openings as illustrated in FIGS. 1A-1B and FIG. 1E.

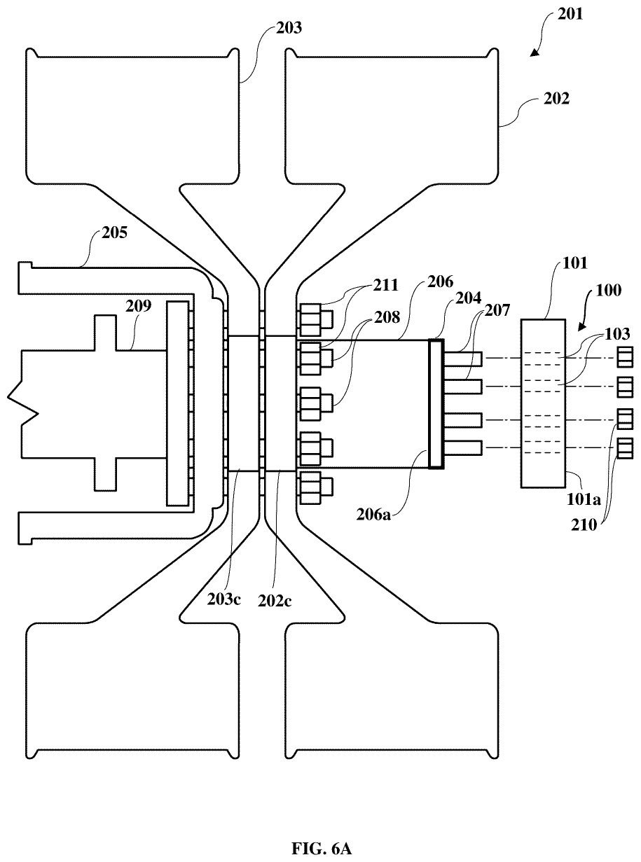

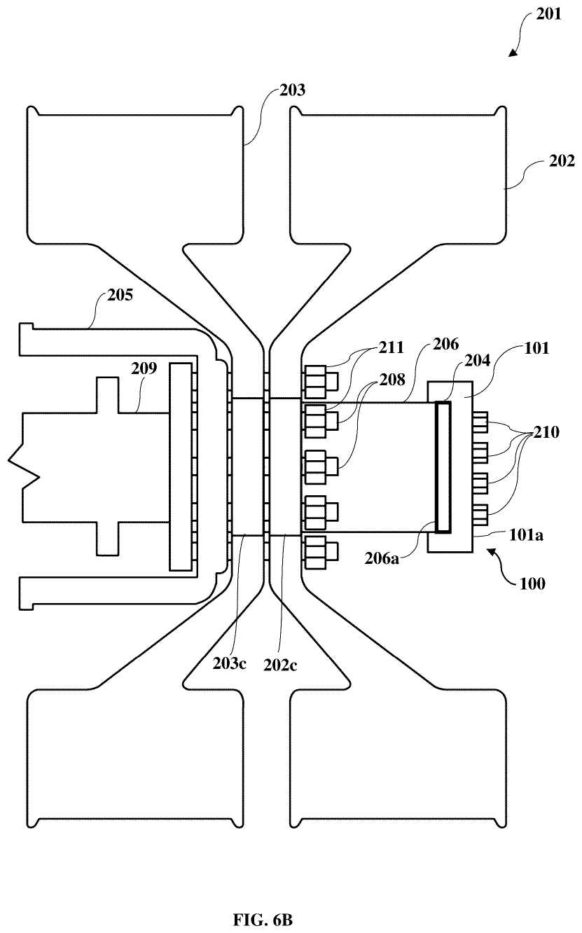

FIG. 2 illustrates a perspective view of a dual-rim automobile 200, showing wheel lock devices 100 securing wheel rims 202 to the dual-rim automobile 200. The wheel rims 202 that house tires of the dual-rim automobile 200 are secured to corresponding axle hubs 206 of the dual-rim automobile 200 by fastening lug nuts 211 onto studs 208 extending from inner ends 206b of the axle hubs 206 as illustrated in FIGS. 3A-3B. The lug nuts 211 prevent the wheel rims 202 from being dislodged from the dual-rim automobile 200. Each wheel lock device 100 is configured to enclose an axle cover 204 and together with the axle cover 204, attach to the corresponding axle hub 206 of the dual-rim automobile 200 as illustrated in FIG. 6B. The outer diameter 101g of the disc member 101 illustrated in FIG. 1D, is generally larger than a central opening 202c defined in the wheel rim, for example, the outer rim 202, thereby restricting and precluding the outer rim 202 from dislodging from the dual-rim automobile 200.

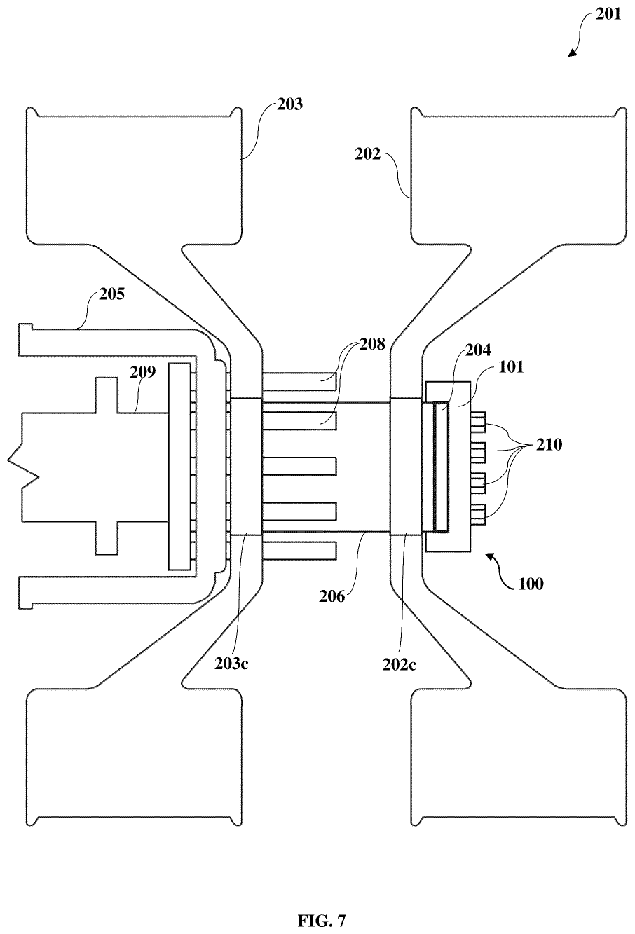

FIG. 3A illustrates an exploded view of a dual-rim assembly 201 utilized in the dual-rim automobile 200 shown in FIG. 2, showing the wheel lock device 100 configured to enclose an axle cover 204 and attach to an axle hub 206 of the dual-rim automobile 200. The dual-rim assembly 201 comprises an outer rim 202 and an inner rim 203 as illustrated in FIG. 3A. The outer rim 202 comprises a central disc 202a with lug holes 202b. The central disc 202a of the outer rim 202 defines a central opening 202c as illustrated in FIG. 3A. Similarly, the inner rim 203 comprises a central disc 203a with lug holes 203b. The central disc 203a of the inner rim 203 defines a central opening 203c as illustrated in FIG. 3A. The outer diameter of each of the central openings 202c and 203c of the outer rim 202 and the inner rim 203, respectively, is generally smaller than the outer diameter 101g of the wheel lock device 100. The central openings 202c and 203c of the outer rim 202 and the inner rim 203, respectively, are configured to fit over the axle hub 206. The central openings 202c and 203c of the outer rim 202 and the inner rim 203, respectively, accommodate the axle hub 206. The axle hub 206 extends from the axle housing 209 as illustrated in FIG. 3A. Multiple elongate studs 208 extend outwardly from a lip member 206b of the axle hub 206. Furthermore, multiple bolts 207 extend outwardly from the outer end 206a of the axle hub 206. Furthermore, a closed cylindrical member, that is, a brake drum 205, is configured to be attached to a wheel of the automobile 200, against which a brake shoe (not shown) presses to make the automobile 200 decelerate or stop. The brake drum 205 and the brake shoe form a friction pair, which decelerates the rotation of the wheel. The axle hub 206 is attached to the brake drum 205 and the axle housing 209 as illustrated in FIGS. 6A-6B and FIG. 7. The brake drum 205 comprises a central disc 205a with lug holes 205b. The central disc 205a of the brake drum 205 defines a central opening 205c as illustrated in FIG. 3A. FIG. 3A also illustrates the lug nuts 211 configured to fasten the outer rim 202, the inner rim 203, and the brake drum 205 to the axle hub 206. Furthermore, FIG. 3A illustrates bolt nuts 210 configured to fasten the wheel lock device 100 and the axle cover 204 to the axle hub 206.

During assembly, the axle hub 206 is inserted into the central opening 205c of the brake drum 205 and thereafter into the central openings 203c and 202c of the inner rim 203 and the outer rim 202, respectively, such that the studs 208 of the axle hub 206 enter into the lug holes 205b of the brake drum 205 and thereafter into the lug holes 203b and 202b of the inner rim 203 and the outer rim 202, respectively. The brake drum 205 and thereafter the inner rim 203 and the outer rim 202 are fit about the axle hub 206 and secured to the axle hub 206 by fastening the lug nuts 211 onto the studs 208 extending from an inner end defined by the lip member 206b of the axle hub 206. The axle cover 204 comprises openings 204a configured to be in fluid communication with the openings 103 of the wheel lock device 100. The wheel lock device 100 is fit over the axle cover 204. The bolts 207 extending from the outer end 206a of the axle hub 206 are configured to be inserted into the openings 204a and 103 of the axle cover 204 and the wheel lock device 100, respectively. The wheel lock device 100 together with the enclosed axle cover 204 is secured to the bolts 207 of the axle hub 206 using the bolt nuts 210.

FIG. 3B illustrates an exploded view of an embodiment of the dual-rim assembly 201 utilized in the dual-rim automobile 200 shown in FIG. 2, showing the wheel lock device 100 configured to enclose an embodiment of the axle cover 204 and attach to the axle hub 206 of the dual-rim automobile 200. In this embodiment, the axle cover 204 is configured as an axle flange attached to a shaft 212 as illustrated in FIG. 3B. The shaft 212 extends perpendicularly from a lower surface 204b of the axle cover 204. In this embodiment, the axle hub 206 comprises an opening 206c configured to receive the shaft 212. During assembly, the shaft 212 that extends from the lower surface 204b of the axle cover 204 is inserted through the openings 202c, 203c, 205c, and 206c of the outer rim 202, the inner rim 203, the brake drum 205, and the axle hub 206, respectively. Shaft teeth 213 configured on one end 212a of the shaft 212 facilitate the transmission of torque from the shaft 212 to the axle hub 206. The disc member 101 of the wheel lock device 100 together with the enclosed axle cover 204 is secured to the bolts 207 of the axle hub 206 using the bolt nuts 210.

FIG. 4 illustrates an assembled view of the dual-rim assembly 201 shown in FIGS. 3A-3B, with the wheel lock device 100 and the enclosed axle cover 204 attached to the axle hub 206 of the dual-rim automobile 200. As illustrated in FIG. 4, the inner rim 203 and the outer rim 202 are secured to the axle hub 206 using the lug nuts 211. The disc member 101 of the wheel lock device 100 encloses the axle cover 204. The disc member 101 together with the enclosed axle cover 204 is attached to the outer end 206a of the axle hub 206 illustrated in FIGS. 3A-3B. In an embodiment, the disc member 101 is secured to the bolts 207 extending from the outer end 206a of the axle hub 206 by fastening the bolt nuts 210 to the bolts 207 illustrated in FIGS. 3A-3B. The one-piece, disc-shaped, wheel lock device 100 utilizes, for example, a minimum of four bolt nuts 210 to hold the disc member 101 in place on the axle cover 204, and in an embodiment, utilizes all the bolt nuts 210 available, for example, eight bolt nuts 210, for fastening the axle cover 204.

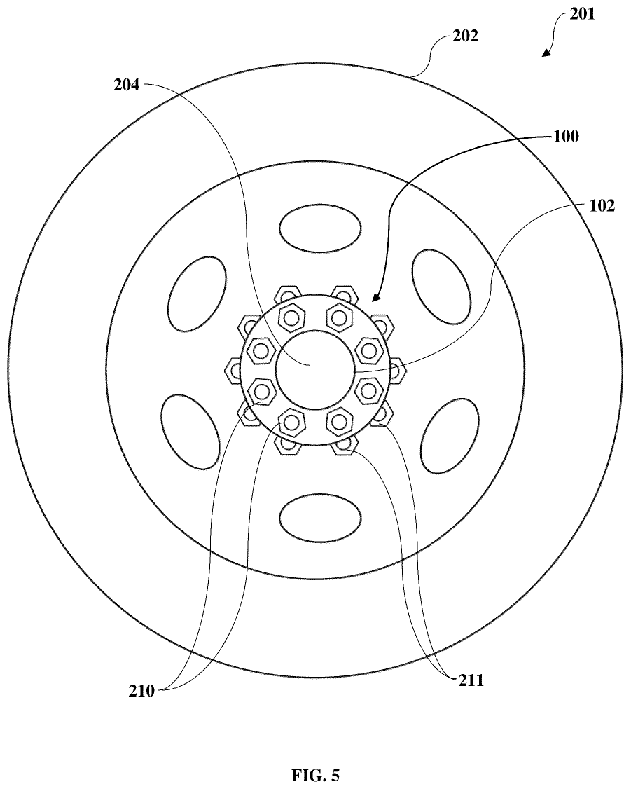

FIG. 5 illustrates a front elevation view of the dual-rim assembly 201 shown in FIG. 4, with the wheel lock device 100 and the enclosed axle cover 204 attached to the axle hub 206 shown in FIGS. 3A-3B, of the dual-rim automobile 200 shown in FIG. 2. The axle cover 204 enclosed by the wheel lock device 100 is visible through the central opening 102 of the wheel lock device 100. FIG. 5 also shows the lug nuts 211 used to fasten the outer rim 202 and the inner rim 203 to the axle hub 206 shown in FIGS. 3A-3B, and the bolt nuts 210 used to fasten the wheel lock device 100 with the enclosed axle cover 204 to the axle hub 206.

FIG. 6A illustrates a cross-sectional, side elevation view of the dual-rim assembly 201, showing the wheel lock device 100 configured to attach to the axle cover 204 at the outer end 206a of the axle hub 206 using bolts 207 and bolt nuts 210. The brake drum 205, the inner rim 203, and the outer rim 202 are coaxially secured to the axle hub 206 by fastening the lug nuts 211 to the studs 208 as illustrated in FIG. 6A. The axle hub 206 passes through the central openings 205c, 203c, and 202c of the brake drum 205, the inner rim 203, and the outer rim 202, respectively, while the studs 208 pass through the lug holes 205b, 203b, and 202b of the brake drum 205, the inner rim 203, and the outer rim 202, respectively, illustrated in FIGS. 3A-3B. The bolts 207 extending from the outer end 206a of the axle hub 206 are inserted into the openings 204a of the axle cover 204 shown in FIGS. 3A-3B. The axle cover 204 is typically attached to the outer end 206a of the axle hub 206 by fastening the bolt nuts 210 to the bolts 207. The wheel lock device 100 is attached to the axle cover 204 and in turn to the outer end 206a of the axle hub 206 by unfastening the bolt nuts 210 from the axle cover 204, placing the wheel lock device 100 over the axle cover 204 such that the bolts 207 pass through the openings 103 of the wheel lock device 100, and fastening the bolts nuts 210 to the bolts 207. FIG. 6A illustrates the position of the wheel lock device 100 with respect to the axle cover 204, before the wheel lock device 100 encloses the axle cover 204 and together with the axle cover 204 attaches to the outer end 206a of the axle hub 206.

FIG. 6B illustrates a cross-sectional, side elevation view of the dual-rim assembly 201, showing the wheel lock device 100 attached to the axle cover 204 at the outer end 206a of the axle hub 206 using bolts 207 and bolt nuts 210. The outer rim 202 and the inner rim 203 are secured to the axle hub 206 using the studs 208 on the axle hub 206 and the lug nuts 211. FIG. 6B shows the lug nuts 211 fixed to the studs 208 to prevent the outer rim 202 and the inner rim 203 from dislodging from the axle hub 206. When the wheel lock device 100 is placed over the axle cover 204, the axle cover 204 is received within the inner space 101d of the wheel lock device 100 shown in FIG. 1B and FIG. 1E. The wheel lock device 100, therefore, encloses the axle cover 204 at the outer end 206a of the axle hub 206 as illustrated in FIG. 6B. On attaching the wheel lock device 100 to the axle cover 204 by fastening the bolts nuts 210 to the bolts 207, the fastened bolt nuts 210 lie flush against the generally circular plate 101a of the wheel lock device 100.

FIG. 7 illustrates a cross-sectional, side elevation view of the dual-rim assembly 201, showing operation of the wheel lock device 100 as a stopper that secures and precludes a wheel rim, for example, an outer rim 202, from dislodging from an automobile 200 shown in FIG. 2, when fasteners, for example, the lug nuts 211, that attach the outer rim 202 to the automobile 200 are unfastened accidentally. When the automobile 200 is in motion, if the lug nuts 211 accidentally unfasten, disengage from the studs 208, and fall off as illustrated in FIG. 7, the wheel lock device 100 secures and precludes the outer rim 202 and/or the inner rim 203 of the automobile 200 from dislodging from the automobile 200. When the lug nuts 211 unfasten, the outer rim 202 and the inner rim 203 may disengage and separate from each other as illustrated in FIG. 7. Since the outer diameter 101g of the wheel lock device 100 illustrated in FIG. 1D is larger than the central openings 202c and 203c defined in the outer rim 202 and the inner rim 203, respectively, the wheel lock device 100 restricts and precludes the outer rim 202 and the inner rim 203 from dislodging from the automobile 200, thereby preventing serious accidents. FIG. 7 shows the outer rim 202 and the inner rim 203 disengaged from each other due to the unfastening of the lug nuts 211, and being precluded from dislodging from the automobile 200 by the wheel lock device 100 acting as a stopper.

If the lug nuts 211 unfasten from the studs 208, the wheel lock device 100 precludes the outer rim 202 and the inner rim 203, and in turn, tires housed thereon, from coming off the axle hub 206 of the automobile 200. In this scenario, if the automobile 200 loses power to its rear wheels, the automobile 200 can pull over safely with the rims 202 and 203 and in turn, the tires, still attached to the automobile 200. The wheel lock device 100 is configured to be attached to any axle having bolts on an outermost part of the axle, for example, bolts 207 on an axle cover 204.

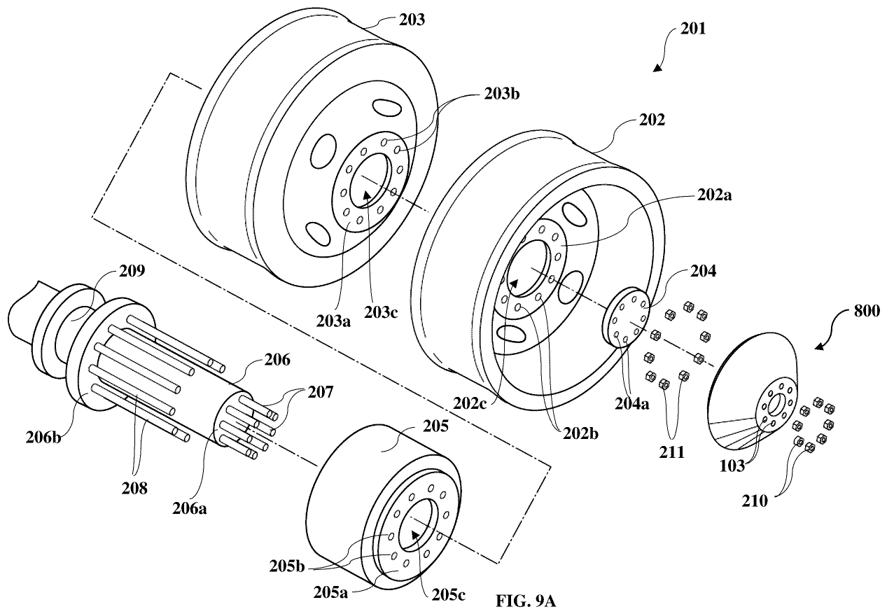

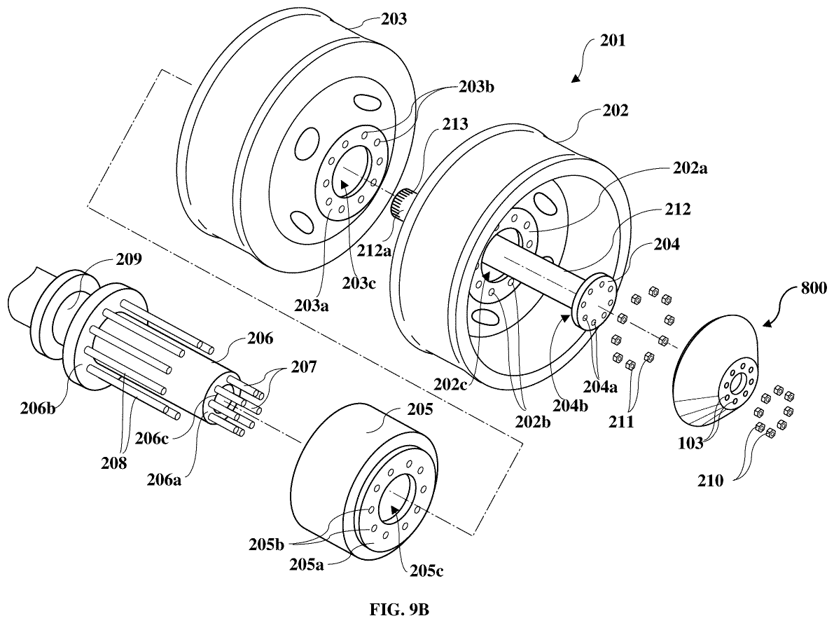

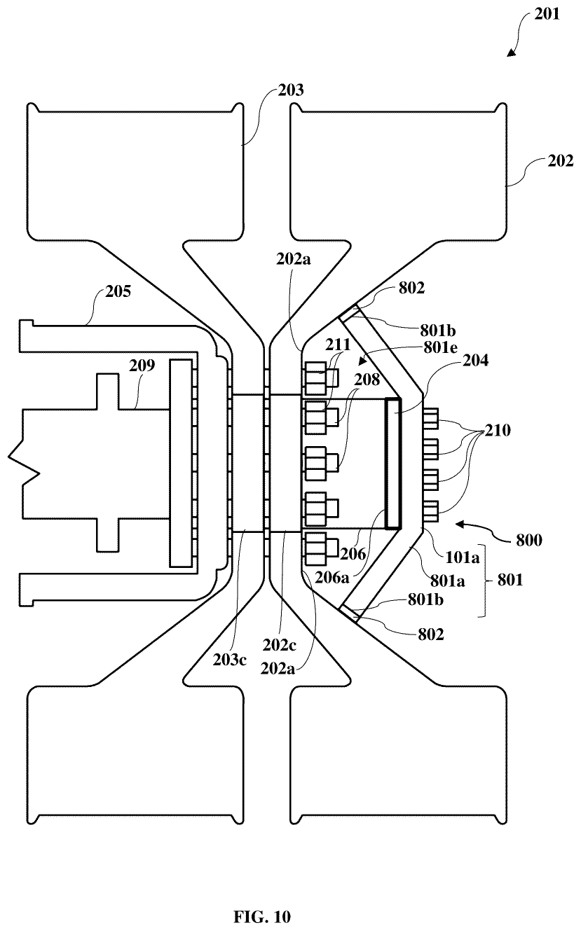

FIGS. 8A-8B illustrate a front perspective view and a rear perspective view of another embodiment of the wheel lock device 800, respectively. In this embodiment, the wheel lock device 800 is shaped similar to a bell. In this embodiment, the stopper member is configured as a conical frustum member 801 comprising a generally circular plate 101a, for example, a ring-shaped plate, with a central opening 102, and a generally hollow frustum wall 801a. The conical frustum member 801 is configured to secure a wheel rim 202 illustrated in FIGS. 9A-9B and FIG. 10, and preclude the wheel rim 202 from dislodging from an automobile 200 illustrated in FIG. 2, when fasteners, for example, lug nuts 211, that attach the wheel rim 202 to the automobile 200 are unfastened accidentally. The generally hollow frustum wall 801a is configured to extend angularly from an edge 101c of the generally circular plate 101a and terminate at a tapered end 801b of the generally hollow frustum wall 801a. In an example, the generally hollow frustum wall 801a extends from a plane of the circular plate 101a by an angle of about 30 degrees to about 60 degrees. The generally circular plate 101a and the generally hollow frustum wall 801a of the conical frustum member 801 define an inner space 801e as illustrated in FIG. 8B and FIG. 8F, configured to receive and enclose an axle cover 204 illustrated in FIGS. 9A-9B and FIG. 10. In an embodiment, the tapered end 801b of the generally hollow frustum wall 801a of the conical frustum member 801 comprises an outward edge 801c and an inward edge 801d configured to firmly secure the conical frustum member 801 to the wheel rim 202.

In an embodiment, the conical frustum member 801 comprises multiple openings 103 annularly disposed about the central opening 102 of the conical frustum member 801. The openings 103 are disposed on the generally circular plate 101a of the conical frustum member 801 as illustrated in FIGS. 8A-8B and FIGS. 8D-8E. The structure and the function of the openings 103 are disclosed in the description of FIGS. 1A-1B.

FIG. 8C illustrates a left-side elevation view of the wheel lock device 800. The tapered end 801b of the conical frustum member 801 of the wheel lock device 800 is illustrated in FIG. 8C. FIGS. 8D-8E illustrate a front elevation view and a rear elevation view of the wheel lock device 800, respectively. The structure and dimensions of the generally circular plate 101a of the conical frustum member 801 is disclosed in the description of FIG. 1D. In an example, the height of the generally hollow frustum wall 801a of the conical frustum member 801 is about 10 inches to about 20 inches; the inner diameter 801f of the generally hollow frustum wall 801a is about 17 inches to about 20 inches, and the outer diameter 801g of the generally hollow frustum wall 801a is about 17.5 inches to about 20.5 inches. The outer diameter 801g of the conical frustum member 801 is generally larger than the outer diameter of a central opening in a wheel rim of a single-rim automobile or generally larger than the outer diameter of a central opening 202c in an outer rim 202 of a dual-rim automobile 200 shown in FIGS. 9A-9B and FIG. 2, therefore, precluding the single-rim or the outer rim 202 from getting past the wheel lock device 800. The wheel lock device 800, therefore, restricts and precludes the outer rim 202 from dislodging from the dual-rim automobile 200.

FIG. 8F illustrates a cross-sectional view of the wheel lock device 800, taken along a sectional line F-F′ shown in FIG. 8E. The cross-sectional view in FIG. 8F illustrates the inner space 801e defined by the generally circular plate 101a and the generally hollow frustum wall 801a of the conical frustum member 801. The cross-sectional view in FIG. 8F also illustrates the openings 103 disposed on the generally circular plate 101a of the conical frustum member 801. The openings 103 are, for example, generally cylindrical openings as illustrated in FIGS. 8A-8B and FIGS. 8D-8E.

FIG. 9A illustrates an exploded view of a dual-rim assembly 201 utilized in the dual-rim automobile 200 shown in FIG. 2, showing the wheel lock device 800 configured to enclose an axle cover 204 and attach to an axle hub 206 of the dual-rim automobile 200. The structure and the assembly of the dual-rim assembly 201 comprising the outer rim 202, the inner rim 203, the brake drum 205, the axle hub 206, and the axle housing 209 are disclosed in the descriptions of FIG. 2 and FIGS. 3A-3B. After the assembly of the dual-rim assembly 201, the wheel lock device 800 is fit over the axle cover 204. The bolts 207 extending from the outer end 206a of the axle hub 206 are configured to be inserted into the openings 204a and 103 of the axle cover 204 and the generally circular plate 101a of the wheel lock device 800, respectively. The wheel lock device 800 together with the enclosed axle cover 204 is secured to the bolts 207 of the axle hub 206 using the bolt nuts 210.

FIG. 9B illustrates an exploded view of an embodiment of the dual-rim assembly 201 utilized in the dual-rim automobile 200 shown in FIG. 2, showing the wheel lock device 800 configured to enclose an embodiment of the axle cover 204 and attach to the axle hub 206 of the dual-rim automobile 200. In this embodiment, the axle cover 204 is configured as an axle flange attached to a shaft 212 as illustrated in FIG. 9B. The shaft 212 extends perpendicularly from the lower surface 204b of the axle cover 204. In this embodiment, the axle hub 206 comprises an opening 206c configured to receive the shaft 212. During assembly, the shaft 212 is inserted through the openings 202c, 203c, 205c, and 206c of the outer rim 202, the inner rim 203, the brake drum 205, and the axle hub 206, respectively. The wheel lock device 800 together with the enclosed axle cover 204 is secured to the bolts 207 of the axle hub 206 using the bolt nuts 210.

FIG. 10 illustrates a cross-sectional, side elevation view of the dual-rim assembly 201, showing the wheel lock device 800 attached to the axle cover 204 at the outer end 206a of the axle hub 206 using the bolts 207 and the bolt nuts 210. As illustrated in FIG. 10, the inner rim 203 and the outer rim 202 are secured to the axle hub 206 using the lug nuts 211. The brake drum 205, the inner rim 203, and the outer rim 202 are coaxially secured to the axle hub 206 by fastening the lug nuts 211 to the studs 208 as illustrated in FIG. 10. FIG. 10 shows the lug nuts 211 fixed to the studs 208 to prevent the outer rim 202 and the inner rim 203 from dislodging from the axle hub 206. The axle hub 206 passes through the central openings 205c, 203c, and 202c of the brake drum 205, the inner rim 203, and the outer rim 202, respectively, while the studs 208 pass through the lug holes 205b, 203b, and 202b of the brake drum 205, the inner rim 203, and the outer rim 202, respectively, illustrated in FIGS. 9A-9B. The bolts 207 extending from the outer end 206a of the axle hub 206 are inserted into the openings 204a of the axle cover 204 shown in FIGS. 9A-9B. The axle cover 204 is typically attached to the outer end 206a of the axle hub 206 by fastening the bolt nuts 210 to the bolts 207. The wheel lock device 800 is attached to the axle cover 204 and in turn to the outer end 206a of the axle hub 206 by unfastening the bolt nuts 210 from the axle cover 204, placing and fitting the wheel lock device 800 over the axle cover 204 such that the bolts 207 pass through the openings 103 of the wheel lock device 800, and fastening the bolts nuts 210 to the bolts 207.

The wheel lock device 800 is fit over the axle cover 204, such that the axle cover 204 is enclosed within the inner space 801e defined by the generally circular plate 101a and the generally hollow frustum wall 801a of the conical frustum member 801, and the openings 103 of the generally circular plate 101a are aligned with the openings 204a of the axle cover 204. The wheel lock device 800, therefore, encloses the axle cover 204 at the outer end 206a of the axle hub 206 as illustrated in FIG. 10. The coaxially disposed openings 204a and 103 of the axle cover 204 and the generally circular plate 101a of the conical frustum member 801, respectively, receive the bolts 207 extending from the outer end 206a of the axle hub 206. The wheel lock device 800 is secured to the bolts 207 using the bolt nuts 210. The tapered end 801b of the conical frustum member 801 is tightened firmly to or proximal to the central disc 202a of the outer rim 202 as illustrated in FIG. 10.

In an embodiment, the wheel lock device 800 further comprises a compression material 802 provided on the tapered end 801b of the generally hollow frustum wall 801a of the conical frustum member 801. The compression material 802 at the tapered end 801b of the generally hollow frustum wall 801a is configured to compress against the wheel rim, that is, the outer rim 202, and firmly secure the conical frustum member 801 to the outer rim 202. In an embodiment, a layer of clastic material is fastened or glued to the tapered end 801b of the generally hollow frustum wall 801a of the conical frustum member 801. The clastic material is configured to cushion the tapered end 801b of the generally hollow frustum wall 801a when the central disc 202a or an area proximal to the central disc 202a of the outer rim 202 contacts the tapered end 801b of the generally hollow frustum wall 801a. In another embodiment (not shown), the tapered end 801b of the generally hollow frustum wall 801a of the conical frustum member 801 is disposed a predetermined distance away from the outer rim 202. For example, the tapered end 801b of the generally hollow frustum wall 801a of the conical frustum member 801 is disposed within an inch of the outer rim 202. The conical frustum member 801 together with the enclosed axle cover 204 is attached to the outer end 206a of the axle hub 206 by inserting the bolts 207 extending from the outer end 206a of the axle hub 206 into the openings 204a and 103 of the axle cover 204 and the generally circular plate 101a of the wheel lock device 800, respectively, and securing the conical frustum member 801 to the bolts 207 by fastening the bolt nuts 210 to the bolts 207 as illustrated in FIG. 10. On attaching the wheel lock device 800 to the axle cover 204 by fastening the bolts nuts 210 to the bolts 207, the fastened bolt nuts 210 lie flush against the generally circular plate 101a of the wheel lock device 800. Similar to the wheel lock device 100 illustrated in FIG. 6B, the wheel lock device 800 together with the enclosed axle cover 204 bolts onto the outer end 206a of the axle hub 206 with a further tightening of the conical frustum member 801 to the central disc 202a of the outer rim 202.

Once installed, the bell-shaped wheel lock device 800 applies pressure on the outer rim 202 or in an embodiment, is disposed within an inch of the outer rim 202. The bell-shaped wheel lock device 800 prevents the outer rim 202 from coming off of the studs 208 if the lug nuts 211 are unfastened accidentally and fall off. Due to the types of wheel rims available and the possibility of having two different wheel rims 202 and 203 on the same axle hub 206, in an embodiment, a shim or an extension ring (not shown) is provided to ensure there is minimal distance between the wheel rims 202 and 203 and the wheel lock device 800. The shim or the extension ring is made of a hard plastic material, for example, polyethylene or polypropylene. There are different combinations of two wheel rims used in an automobile, for example, (a) two steel rims comprising an inner steel rim and an outer steel rim; (b) an inner steel rim and an outer aluminum rim; and (c) two aluminum rims comprising an inner aluminum rim and an outer aluminum rim. Each steel rim has a thickness of, for example, about 0.5 inch and each aluminum rim has a thickness of, for example, about 1 inch. The total thickness of the two wheel rim ranges, for example, from about 1 inch to about 2 inches. The bell-shaped wheel lock device 800 illustrated in FIGS. 8A-8F is of a larger size than that of the disc-shaped wheel lock device 100 illustrated in FIGS. 1A-1E, has additional parts, requires more material, requires more machining, and weighs more than the disc-shaped wheel lock device 100. The bell-shaped wheel lock device 800 is applicable for trailers due to the design of a trailer hub versus the design of a truck hub. A truck comprises an axle that connects to each truck hub on one end and connects to a differential in the center. A tractor hub has a larger diameter than that of the truck hub and has, for example, eight ⅜-inch bolts that secure the axle cover 204 thereon. The trailer hub is smaller in size than the truck hub and the tractor hub and is hollow due to the absence of an axle inside. The smaller trailer hub has, for example, five 5/16-inch bolts to secure a grease cap thereon. The 5/16-inch bolts may not be able to withstand the force of a wheel rim applying pressure thereon. Replacing the five bolts with high grade studs may be sufficient to hold the wheel lock device 800 thereon and withstand the force. Trailer hubs can be manufactured to have the same dimensions as the truck hubs for fitting the wheel lock device 800 thereon.

When an automobile is in motion, if the lug nuts 211 accidentally unfasten, disengage from the studs 208, and fall off, the wheel lock device 800 secures and precludes the outer rim 202 and/or the inner rim 203 of the automobile 200, from dislodging from the automobile. When the lug nuts 211 unfasten, the outer rim 202 and the inner rim 203 may disengage and separate from each other. Since the outer diameter 801g of the wheel lock device 800 illustrated in FIG. 8E is larger than the central openings 202c and 203c defined in the outer rim 202 and the inner rim 203, respectively, illustrated in FIGS. 9A-9B, the wheel lock device 800 restricts and precludes the outer rim 202 and the inner rim 203 from dislodging from the automobile, thereby preventing serious accidents.

If the lug nuts 211 unfasten from the studs 208, the wheel lock device 800 precludes the outer rim 202 and the inner rim 203, and in turn, tires housed thereon, from coming off the axle hub 206 of the automobile. In this scenario, if the automobile loses power to its rear wheels, the automobile can pull over safely with the rims 202 and 203 and in turn, the tires, still attached to the automobile. The wheel lock device 800 is configured to be attached to any axle having bolts on an outermost part of the axle, for example, bolts 207 on an axle cover 204.

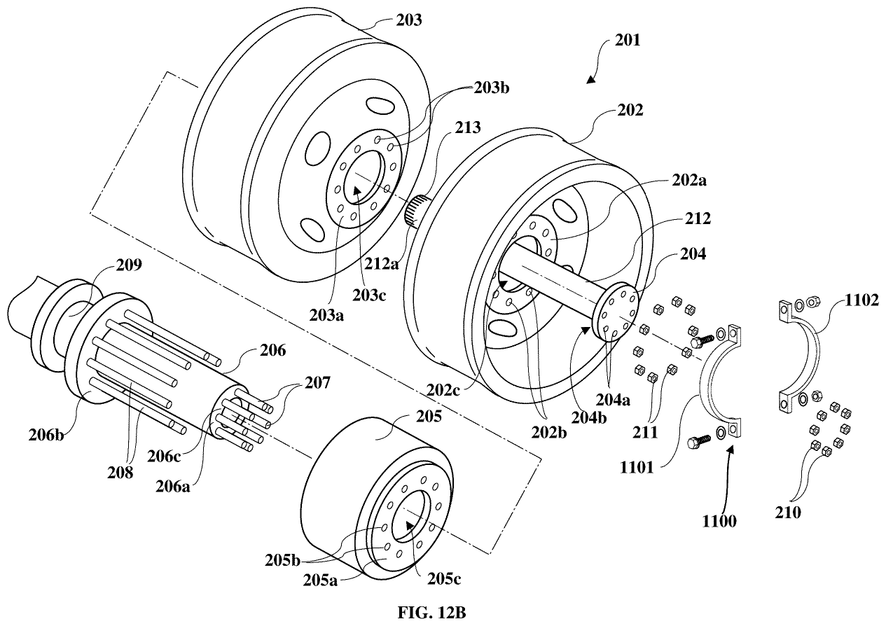

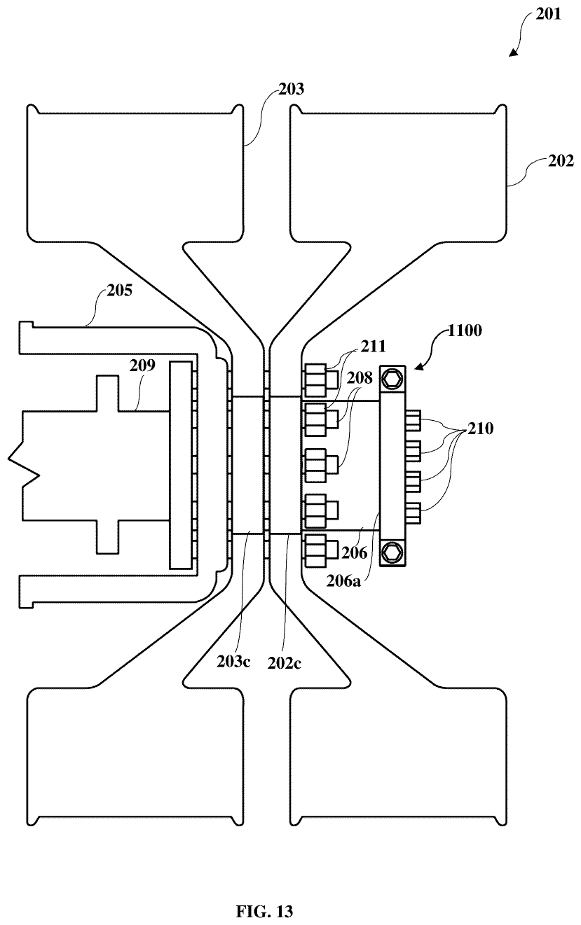

FIGS. 11A-11B illustrate a left-side perspective view and a right-side perspective view of another embodiment of the wheel lock device 1100, respectively. In this embodiment, the stopper member is configured as a clamp member 1103 comprising a first clamping element 1101 and a second clamping element 1102 configured to surround and enclose the axle cover 204 illustrated in FIGS. 12A-12B. In an embodiment, the first clamping element 1101 and the second clamping element 1102 of the clamp member 1103 are generally hemispherical in shape. The first clamping element 1101 and the second clamping element 1102 represent two halves that bolt together using fasteners 1106 and 1107 illustrated in FIGS. 11C-11F. For example, the first clamping element 1101 is placed on a first half of an outer circumference of the axle cover 204, and the second clamping element 1102 is placed on a second half of the outer circumference of the axle cover 204 opposite to the first clamping element 1101. In an embodiment, the first clamping element 1101 comprises arms 1104a and 1104b extending outwardly from opposing ends 1101a and 1101b of the first clamping element 1101, respectively. Similarly, the second clamping element 1102 comprises arms 1105a and 1105b extending outwardly from opposing ends 1102a and 1102b of the second clamping element 1102, respectively. Each of the arms 1104a, 1104b, 1105a, and 1105b are, for example, of a rectangular shape. In an embodiment, the arms 1104a and 1104b of the first clamping element 1101 are attached to corresponding arms 1105a and 1105b of the second clamping element 1102 using the fasteners 1106 and 1107 to secure the clamp member 1103 around the axle cover 204 and preclude a wheel rim, for example, an outer rim 202 illustrated in FIGS. 12A-12B and FIG. 13, from dislodging from an automobile.

The fastener 1106 comprises a bolt 1106a, a locking nut 1106c, and washers 1106b and 1106d configured to pressure-fit connect the arms 1104a and 1105a of the first clamping element 1101 and the second clamping element 1102, respectively, as disclosed in the description of FIG. 11C. Similarly, the fastener 1107 comprises a bolt 1107a, a locking nut 1107c, and washers 1107b and 1107d configured to pressure-fit connect the arms 1104b and 1105b of the first clamping element 1101 and the second clamping element 1102, respectively, as disclosed in the description of FIG. 11C. The fastened first clamping element 1101 and second clamping element 1102 of the clamp member 1103 define a space 1108 configured to receive and enclose the axle cover 204.

FIG. 11C illustrates an exploded, front elevation view of the embodiment of the wheel lock device 1100 shown in FIG. 11A. The arms 1104a and 1104b of the first clamping element 1101 comprise openings 1104c and 1104d, respectively, as illustrated in FIGS. 12A-12B. Similarly, the arms 1105a and 1105b of the second clamping element 1102 comprise openings 1105c and 1105d, respectively, as illustrated in FIGS. 12A-12B. In an embodiment, the washers 1106b, 1106d and 1107b, 1107d of the fasteners 1106 and 1107, respectively, are ring-shaped washers comprising openings 1106f, 1106e and 1107f, 1107e configured to receive the bolts 1106a and 1107a of the fasteners 1106 and 1107, respectively, as illustrated in FIGS. 12A-12B. For example, the washers 1106b, 1106d and 1107b, 1107d are nylon rings. The first clamping element 1101 and the second clamping element 1102 are configured to face each other for mutually aligning their respective upper arms 1104a and 1105a and their respective lower arms 1104b and 1105b. Mutual alignment of the upper arms 1104a and 1105a and the lower arms 1104b and 1105b of the first clamping element 1101 and the second clamping element 1102 mutually aligns their respective openings 1104c, 1105c and 1104d, 1105d. The openings 1106f and 1106e of the washers 1106b and 1106d, respectively, are mutually aligned with the openings 1104c and 1105c of the upper arms 1104a and 1105a, respectively. The openings 1107f and 1107e of the washers 1107b and 1107d, respectively, are mutually aligned with the openings 1104d and 1105d of the lower arms 1104b and 1105b, respectively.

FIG. 11D illustrates an assembled, front elevation view of the embodiment of the wheel lock device 1100 shown in FIG. 11A. The clamp member 1103 fits around the axle cover 204 illustrated in FIGS. 12A-12B. To fasten the wheel lock device 1100 around the axle cover 204, the first clamping element 1101 and the second clamping element 1102 are mutually aligned and fastened by the fasteners 1106 and 1107. That is, the upper arms 1104a and 1105a of the first clamping element 1101 and the second clamping element 1102, respectively, are connected to each other using the bolt 1106a, and the lower arms 1104b and 1105b of the first clamping element 1101 and the second clamping element 1102, respectively, are connected to each other using the bolt 1107a as illustrated in FIGS. 11A-11B. The bolt 1106a is inserted through the opening 1106f of the washer 1106b, and then into the openings 1104c and 1105c of the upper arms 1104a and 1105a, respectively, and then into the opening 1106e of the washer 1106d and the locking nut 1106c illustrated in FIGS. 12A-12B. The locking nut 1106c fastens the inserted bolt 1106a against the upper arm 1105a of the second clamping element 1102 via the washer 1106d as illustrated in FIG. 11D. Similarly, the bolt 1107a is inserted through the opening 1107f of the washer 1107b, and then into the openings 1104d and 1105d of the lower arms 1104b and 1105b, respectively, and then into the opening 1107e of the washer 1107d and the locking nut 1107c illustrated in FIGS. 12A-12B. The locking nut 1107c fastens the inserted bolt 1107a against the lower arm 1105b of the second clamping element 1102 via the washer 1107d as illustrated in FIG. 11D.

In an example, the inner diameter 1109a of the clamp member 1103 is about 8.5 inches to about 12 inches; and the outer diameter 1109b of the clamp member 1103 is about 10 inches to about 12.5 inches. In another example, the inner diameter 1109a of the clamp member 1103 is about 3 inches to about 24 inches; and the outer diameter 1109b of the clamp member 1103 is about 8.5 inches to about 25 inches. The thickness of the first clamping element 1101, the second clamping element 1102, and each of the arms 1104a, 1104b, 1105a, and 1105b of the clamp member 1103 is, for example, about 0.25 inch to about 2 inches. Moreover, the width of the first clamping element 1101, the second clamping element 1102, and each of the arms 1104a, 1104b, 1105a, and 1105b of the clamp member 1103 is, for example, about 1 inch to about 5 inches. Furthermore, the height of the clamp member 1103 is, for example, about 4.5 inches to about 27 inches.

FIG. 11E illustrates a left-side elevation view of the wheel lock device 1100. FIG. 11F illustrates a cross-sectional view of the wheel lock device 1100, taken along a sectional line X-X′ shown in FIG. 11E. The cross-sectional view in FIG. 11F shows the connection of the upper arms 1104a, 1105a and the lower arms 1104b and 1105b by the inserted bolts 1106a and 1107a fastened by the nuts 1106c and 1107c, respectively.

FIG. 12A illustrates an exploded view of a dual-rim assembly 201 utilized in the dual-rim automobile 200 shown in FIG. 2, showing the wheel lock device 1100 configured to enclose an axle cover 204 and attach to an axle hub 206 of the dual-rim automobile 200. The structure and the assembly of the dual-rim assembly 201 comprising the outer rim 202, the inner rim 203, the brake drum 205, the axle hub 206, and the axle housing 209 are disclosed in the descriptions of FIG. 2 and FIGS. 3A-3B. The bolts 207 extending from the outer end 206a of the axle hub 206 are configured to be inserted into the openings 204a of the axle cover 204. The two halves of the wheel lock device 1100, that is, the first clamping element 1101 and the second clamping element 1102 of the clamp member 1103, match the circumference of the outermost part, for example, the lip member 206b, of the axle hub 206. The wheel lock device 1100 is clamped around the axle cover 204 and secured by the fasteners 1106 and 1107 illustrated in FIGS. 11C-11F. The axle cover 204 surrounded and clamped by the wheel lock device 1100 is secured to the bolts 207 of the axle hub 206 using the bolt nuts 210.

Due to varying design of the axle hub 206 where the clamp member 1103 is configured to mount, the clamp member 1103 is configured with multiple clamp sizes determined by axle application. In an example, the clamp size of the clamp member 1103 is about 9 inches. The arms 1104a, 1104b and 1105a, 1105b are bent out on the opposing ends 1101a, 1101b and 1102a, 1102b of the clamping elements 1101 and 1102, respectively, for the bolts 1106a and 1107a to pass through. A gap is provided between the upper arms 1104a and 1105a and the lower arms 1104b and 1105b to allow the bolts 1106a and 1107a to squeeze the two halves, that is, the first clamping element 1101 and the second clamping element 1102, of the clamp member 1103 together. The locking nuts 1106c and 1107c are provided to preclude one or more of the bolts 1106a and 1107a from unfastening the clamp member 1103. In an embodiment, the locking nuts 1106c and 1107c are castle nuts with cotter pins. The locking nuts 1106c and 1107c are tightened to an appropriate tension to optimally lock the bolts 1106a and 1107a, respectively, and preclude the clamp member 1103 from unfastening. For example, about 90 pound-foot (lb-ft) of torque is used to tighten the locking nuts 1106c and 1107c to optimally lock the bolts 1106a and 1107a, respectively, and in turn, secure the clamp member 1103 about the axle cover 204. In an embodiment, the amount of torque, tension, or pressure to be applied to secure the clamp member 1103 about the axle cover 204 is determined by circumference of the axle cover 204. In another embodiment, fastening devices such as cotter pins, split pins, spring washers, nylon insert lock nuts, etc., or any combination thereof, are used for locking the first clamping element 1101 and the second clamping element 1102 of the clamp member 1103 together and for preventing the bolts 1106a and 1107a from loosening.

FIG. 12B illustrates an exploded view of the dual-rim assembly 201 utilized in the dual-rim automobile 200 shown in FIG. 2, showing the wheel lock device 1100 configured to enclose an embodiment of the axle cover 204 and attach to the axle hub 206 of the dual-rim automobile 200. In this embodiment, the axle cover 204 is configured as an axle flange attached to a shaft 212 as illustrated in FIG. 12B. The shaft 212 extends perpendicularly from the lower surface 204b of the axle cover 204. In this embodiment, the axle hub 206 comprises an opening 206c configured to receive the shaft 212. During assembly, the shaft 212 is inserted through the openings 202c, 203c, 205c, and 206c of the outer rim 202, the inner rim 203, the brake drum 205, and the axle hub 206, respectively. The wheel lock device 1100 is clamped around the axle cover 204. The axle cover 204 surrounded and clamped by the wheel lock device 1100 is secured to the bolts 207 of the axle hub 206 using the bolt nuts 210.

FIG. 13 illustrates a cross-sectional, side elevation view of the dual-rim assembly 201, showing the wheel lock device 1100 clamped around the axle cover 204 shown in FIGS. 12A-12B. As illustrated in FIG. 13, the inner rim 203 and the outer rim 202 are secured to the axle hub 206 using the lug nuts 211. The brake drum 205, the inner rim 203, and the outer rim 202 are coaxially secured to the axle hub 206 by fastening the lug nuts 211 to the studs 208 as illustrated in FIG. 13. FIG. 13 shows the lug nuts 211 fixed to the studs 208 to prevent the outer rim 202 and the inner rim 203 from dislodging from the axle hub 206. The axle hub 206 passes through the central openings 205c, 203c, and 202c of the brake drum 205, the inner rim 203, and the outer rim 202, respectively, while the studs 208 pass through the lug holes 205b, 203b, and 202b of the brake drum 205, the inner rim 203, and the outer rim 202, respectively, illustrated in FIGS. 12A-12B. The bolts 207 extending from the outer end 206a of the axle hub 206 are inserted into the openings 204a of the axle cover 204 shown in FIGS. 12A-12B. The axle cover 204 is attached to the outer end 206a of the axle hub 206 by fastening the bolt nuts 210 to the bolts 207. The wheel lock device 1100 is clamped around the attached axle cover 204 by pressure-fit connecting the upper arms 1104a and 1105a and the lower arms 1104b and 1105b of the clamp member 1103 using the fasteners 1106 and 1107, respectively, as disclosed in the descriptions of FIGS. 11A-11D. The wheel lock device 1100 precludes the wheel rim, that is, the outer rim 202, from dislodging from an automobile.

The wheel lock device 1100 is fit around the axle cover 204, such that the axle cover 204 is tightly enclosed within the space 1108 defined by the fastened first clamping element 1101 and the second clamping element 1102 of the clamp member 1103 illustrated in FIGS. 11A-11B, FIG. 11D, and FIG. 11F. The wheel lock device 1100, therefore, encloses the axle cover 204 at the outer end 206a of the axle hub 206 as illustrated in FIG. 13. The enclosed axle cover 204 together with the wheel lock device 1100 is attached to the outer end 206a of the axle hub 206 by inserting the bolts 207 extending from the outer end 206a of the axle hub 206 into the openings 204a of the axle cover 204 illustrated in FIGS. 12A-12B, and securing the axle cover 204 to the bolts 207 by fastening the bolt nuts 210 to the bolts 207 as illustrated in FIG. 13. On attaching the axle cover 204 to the outer end 206a of the axle hub 206, the fastened bolt nuts 210 lie flush against the axle cover 204. The upper arms 1104a and 1105a and the lower arms 1104b and 1105b of the clamp member 1103 extend outwardly and preclude a wheel rim, for example, an outer rim 202 illustrated in FIGS. 12A-12B and FIG. 13, from dislodging from the automobile.

When an automobile is in motion, if the lug nuts 211 accidentally unfasten, disengage from the studs 208, and fall off, the wheel lock device 1100 secures and precludes the outer rim 202 and/or the inner rim 203 of the automobile, from dislodging from the automobile. When the lug nuts 211 unfasten, the outer rim 202 and the inner rim 203 may disengage and separate from each other. Since the diameter 1109b and height of the wheel lock device 1100 illustrated in FIG. 11D is larger than the central openings 202c and 203c defined in the outer rim 202 and the inner rim 203, respectively, illustrated in FIGS. 12A-12B, the wheel lock device 1100 restricts and precludes the outer rim 202 and the inner rim 203 from dislodging from the automobile, thereby preventing serious accidents. Furthermore, the outwardly extending upper arms 1104a and 1105a and the lower arms 1104b and 1105b of the clamp member 1103 restrict and preclude the outer rim 202 and the inner rim 203 from dislodging from the automobile.

If the lug nuts 211 unfasten from the studs 208, the wheel lock device 1100 precludes the outer rim 202 and the inner rim 203, and in turn, tires housed thereon, from coming off the axle hub 206 of the automobile. In this scenario, if the automobile loses power to its rear wheels, the automobile can pull over safely with the rims 202 and 203 and in turn, the tires, still attached to the automobile.

In another embodiment (not shown), an axle is configured such that the axle cover has a larger outer diameter than the opening(s) 202c/203c of the wheel rim(s) 202/203. This method comprises breaking an axle seal and pulling the axle out to remove the wheel rim(s) 202/203. In this embodiment, the larger axle cover is configured as the wheel lock device. Any time the wheel(s) needs to come off the automobile for servicing, the axle seal between the axle cover and the axle hub is broken and needs to be re-scaled. In this embodiment, all eight bolts of the axle cover would have to be removed as opposed to pulling four bolts and leaving the axle cover and the axle seal undisturbed.

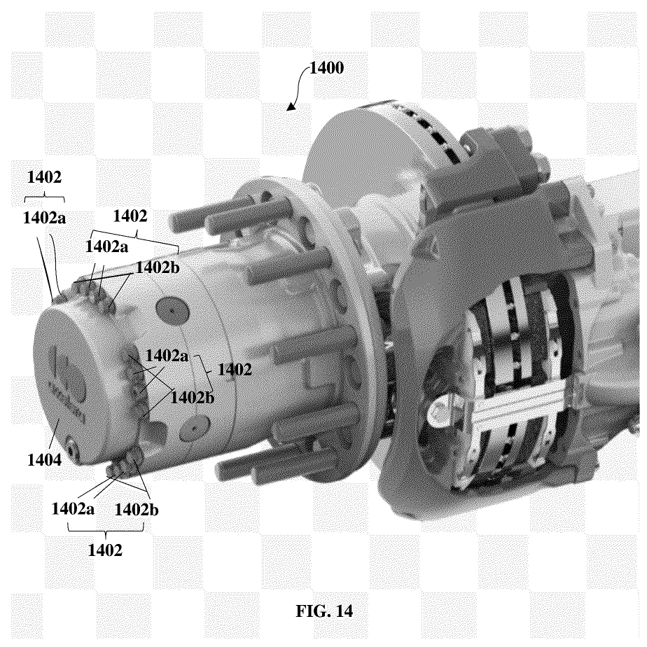

FIG. 14 illustrates an embodiment of an electric truck axle hub 1400. The electric truck axle hub 1400 comprises about 5 sets 1402 of axle hub bolts 1402a and 1402b. In FIG. 14, one of the 5 sets 1402 of axle hub bolts 1402a and 1402b is not visible. Each of the sets 1402 of axle hub bolts 1402a and 1402b comprise about 4 bolts each, as shown in FIG. 14. Two of the axle hub bolts 1402a are located in the middle of each of the sets 1402, and two of the axle hub bolts 1402b are located on either end of each of the sets 1402.

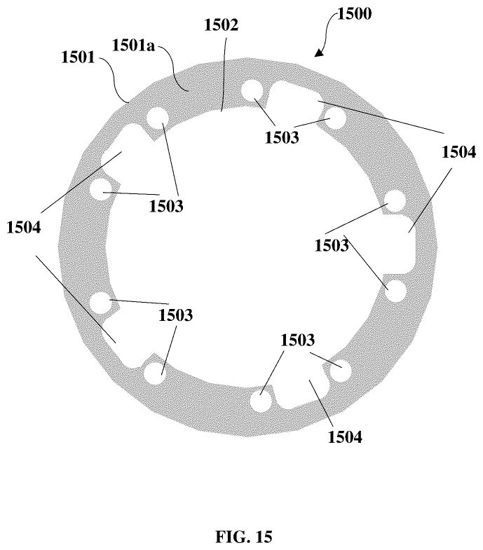

FIG. 15 illustrates a front elevation view of another embodiment of the wheel lock device 1500. The wheel lock device 1500 comprises a disc member 1501 configured as a stopper to secure a wheel rim, for example, wheel rim 202 or a wheel rim (not shown) of an electric truck (not shown) and preclude the wheel rim from dislodging from the electric truck, when fasteners, for example, lug nuts 211 illustrated in FIGS. 3A-3B, that attach the wheel rim to the electric truck are unfastened accidentally. In an embodiment as illustrated in FIG. 15, the disc member 1501 comprises a generally circular plate 1501a with a central opening 1502. The central opening 1502 is configured to accommodate an axle cover 1401 of the electric truck axle hub 1400 as illustrated in FIG. 14. In an embodiment, the central opening 1502 encircles the axle cover 1401 of the electric truck axle hub 1400.

In an embodiment, the wheel lock device 1500 shown in FIG. 15 is configured to be attached to the electric truck axle hub 1400 shown in FIG. 14. The electric truck axle hub 1400 comprises 5 sets 1402 of 4 axle hub bolts 1402a each. In an embodiment, 10 of the 20 axle hub bolts 1402a would hold the wheel lock device 1500 in place i.e., attached to the electric truck axle hub 1400. For example, the axle hub bolts 1402b located on either end of each of the sets 1402 are configured to be inserted through openings 1503 in the wheel lock device 1500. The center section 1504 of the wheel lock device 1500 directly above or corresponding to axle hub bolts 1402a of each set 1402 of 4 axle hub bolts 1402a and 1402b is machined out to fit around the axle hub bolts 1402a which are factory fit bolt. This will ensure that the electric truck axle hub 1400 will not have to be completely loosened up for the installation of the wheel lock device 1500. This will also allow the wheel lock device 1500 to be easily removed when wheels need to be removed. The factory fit (10) ½ inch bolts corresponding to the axle hub bolts 1402b would be replaced with longer high grade bolts to accommodate the thickness of the wheel lock device 1500. The bolts for example, axle hub bolts 1402b and/or 1402a would be torqued to 45 pound-foot (lb-ft). The outside diameter of the wheel lock device 1500 would be the same as the embodiments of the wheel lock device 100 and/or 1100. In an embodiment, about 90 pound-foot (lb-ft) of torque is used to tighten the axle hub bolts 1402b and/or 1402a on a ⅝ nut and or stud on axel. The wheel lock device 1500 may be available in various disc member 1501 diameters and various diameters of the central opening 1502. Furthermore, the diameters of openings 1503 may also vary based on the need. The number of openings 1503 and their location may also vary based on the need.

The foregoing examples and illustrative implementations of various embodiments have been provided merely for explanation and are in no way to be construed as limiting the embodiments disclosed herein. Dimensions of various parts of the wheel lock device 100/800/1100 disclosed above are exemplary, and are not limiting of the scope of the embodiments herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

I claim:

1. A wheel lock device comprising:
a disc member configured to enclose an axle cover and together with the axle cover, attach to an axle hub of an automobile, wherein the disc member is configured as a stopper to secure and preclude a wheel rim from dislodging from the automobile, when fasteners that attach the wheel rim to the automobile are unfastened accidentally.

2. The wheel lock device of claim 1, wherein an outer diameter of the disc member is generally larger than a central opening defined in the wheel rim, thereby restricting and precluding the wheel rim from dislodging from the automobile.

3. The wheel lock device of claim 1, wherein the disc member comprises a generally circular plate with a central opening and a generally hollow cylindrical wall, wherein the generally hollow cylindrical wall is configured to extend substantially perpendicularly from an edge of the generally circular plate.

4. The wheel lock device of claim 3, wherein the generally circular plate and the generally hollow cylindrical wall of the disc member define an inner space configured to receive and enclose the axle cover.

5. The wheel lock device of claim 1, wherein the disc member comprises a plurality of openings annularly disposed about a central opening of the disc member, wherein the openings are configured to receive bolts extending from an outer end of the axle hub, and wherein the disc member is secured to the bolts using bolt nuts.

6. The wheel lock device of claim 1, wherein the wheel rim is secured to the axle hub by fastening the fasteners onto studs extending from an inner end of the axle hub, wherein the fasteners comprise lug nuts.

7. The wheel lock device of claim 1, wherein the wheel rim comprises an opening configured to fit over the axle hub.

8. The wheel lock device of claim 1, wherein the axle hub is attached to a brake drum and an axle housing of the automobile.

9. The wheel lock device of claim 1, wherein the wheel rim is one of a single rim utilized in a single-rim automobile and a dual-rim utilized in a dual-rim automobile.

10. A wheel lock device comprising:
a stopper member configured to enclose an axle cover and together with the axle cover, attach to an axle hub of an automobile, wherein the stopper member is configured to secure and preclude a wheel rim from dislodging from the automobile, when fasteners that attach the wheel rim to the automobile are unfastened accidentally.

11. The wheel lock device of claim 10, wherein an outer diameter of the stopper member is generally larger than a central opening defined in the wheel rim, thereby restricting and precluding the wheel rim from dislodging from the automobile.

12. The wheel lock device of claim 10, wherein the stopper member is configured as a disc member comprising a generally circular plate with a central opening and a generally hollow cylindrical wall, wherein the generally hollow cylindrical wall is configured to extend substantially perpendicularly from an edge of the generally circular plate.

13. The wheel lock device of claim 12, wherein the generally circular plate and the generally hollow cylindrical wall of the disc member define an inner space configured to receive and enclose the axle cover.

14. The wheel lock device of claim 10, wherein the stopper member is configured as a conical frustum member comprising a generally circular plate with a central opening and a generally hollow frustum wall, wherein the generally hollow frustum wall is configured to extend angularly from an edge of the generally circular plate and terminate at a tapered end of the generally hollow frustum wall.

15. The wheel lock device of claim 14, wherein the tapered end of the generally hollow frustum wall of the conical frustum member comprises an outward edge and an inward edge configured to firmly secure the conical frustum member to the wheel rim.

16. The wheel lock device of claim 15, further comprising a compression material provided on the tapered end of the generally hollow frustum wall of the conical frustum member and configured to compress against the wheel rim and firmly secure the conical frustum member to the wheel rim.

17. The wheel lock device of claim 14, wherein the tapered end of the generally hollow frustum wall of the conical frustum member is disposed a predetermined distance away from the wheel rim.

18. The wheel lock device of claim 10, wherein the stopper member comprises a plurality of openings annularly disposed about a central opening of the stopper member, wherein the openings are configured to receive bolts extending from an outer end of the axle hub.

19. The wheel lock device of claim 10, wherein the stopper member is secured to bolts extending from an outer end of the axle hub using bolt nuts.

20. The wheel lock device of claim 10, wherein the stopper member is configured as a clamp member comprising a first clamping element and a second clamping element configured to surround and enclose the axle cover, wherein the first clamping element and the second clamping element are generally hemispherical in shape, wherein the clamp member further comprises arms extending outwardly from opposing ends of each of the first clamping element and the second clamping element, and wherein the arms of the first clamping element are pressure-fit connected to corresponding arms of the second clamping element using fasteners to secure the clamp member around the axle cover and preclude the wheel rim from dislodging from the automobile.
